(19) United States
(12) Patent Application Publication
(10) Pub. No.: US 2026/0370125 A1
(43) Pub. Date: Nov. 19, 2026

(54) POWER SUPPLY SYSTEMS WITH GALLIUM NITRIDE SWITCHES AND CONTROL METHODS THEREOF

(71) Applicant: ON-BRIGHT INTEGRATIONS CO., LTD., Shanghai (CN)

(72) Inventors: Liqiang Zhu, Shanghai (CN); Lieyi Fang, Shanghai (CN); Zhiliang Chen, Shanghai (CN)

(21) Appl. No.: 19/676,711

(22) Filed: May 13, 2026

(30) Foreign Application Priority Data
May 15, 2025 (CN) 202510629483.X

(51) Int. Cl. H02M 1/08; H02M 3/335

(52) U.S. Cl. CPC H02M 1/08; H02M 3/33569

(57) ABSTRACT

Control chip for a power supply system with a GaN switch and method thereof. For example, a control chip for a power supply system with a GaN switch includes: a first terminal connected to the GaN switch; a second terminal connected to a supply capacitor, the supply capacitor being configured to provide a supply voltage to the second terminal; a supply transistor connected between the second terminal and the first terminal; and a driver control module configured to generate a supply control signal to turn on the supply transistor and further configured to generate the supply control signal to turn off the supply transistor; wherein the control chip is configured to: in response to the supply transistor being turned on, allow a charging current to flow from the first terminal through the second terminal to charge the supply capacitor.

### 1. CROSS-REFERENCES TO RELATED APPLICATIONS

This application claims priority to Chinese Patent Application No. 202510629483.X, filed May 15, 2025, incorporated by reference herein for all purposes.

### 2. FIELD OF THE DISCLOSURE

Certain embodiments of the present disclosure are directed to circuits. More particularly, some embodiments of the disclosure provide power supply systems and control methods thereof. Merely by way of example, some embodiments of the disclosure have been applied to power supply systems with gallium nitride (GaN) switches. But it would be recognized that the disclosure has a much broader range of applicability.

### 3. BACKGROUND OF THE DISCLOSURE

Conventional power devices based on wide-bandgap semiconductor materials (e.g., GaN) usually possess low on-resistance and low parasitic capacitance without body diode effect. These types of power devices often can be used to improve operating frequency and efficiency of switching power supply systems.

FIG. 1 is a simplified diagram showing a conventional switching power supply system with a GaN power switch. The switching power supply system 100 includes a full-wave rectifier 110, a control chip 120, a high-voltage startup unit 130, a GaN power switch 140 (e.g., a GaN transistor), a transformer that includes a primary winding 150, a secondary winding 152, and an auxiliary winding 154, diodes 160 and 162, an input capacitor 170, an output capacitor 172, a supply capacitor 174, and a current sensing resistor 180. The control chip 120 includes a terminal 198 (e.g., HV), a terminal 102 (e.g., SW), a terminal 104 (e.g., CS), a terminal 106 (e.g., GND), and a terminal 108 (e.g., VDD). Additionally, the control chip 120 includes a pulse-width-modulation (PWM) control module 122, a gate driver 124, and a power switch 126. Moreover, the high-voltage startup unit 130 is implemented by using one or more high-voltage components (e.g., one or more high-voltage resistors and/or one or more junction field-effect transistors). Also, the switching power supply system 100 is used to provide power to a load 192, wherein the load 192 is configured to receive the power from the power supply system 100.

As shown in FIG. 1, the voltage at the terminal 108 (e.g., VDD) of the control chip 120 serves as a supply voltage for the control chip 120. When the switching power supply system 100 receives an AC voltage 190, the full-wave rectifier 110 rectifies the AC voltage 190 to generate a voltage 111. The voltage 111 is received by a terminal of the input capacitor 170, which includes another terminal biased to a system ground of the switching power supply system 100. Additionally, the voltage 111 charges the supply capacitor 174 via the high-voltage startup unit 130 to cause the voltage at one terminal of the supply capacitor 174 to rise gradually, wherein the one terminal of the supply capacitor 174 is connected to the terminal 108 (e.g., VDD) of the control chip 120, and the voltage at the one terminal of the supply capacitor 174 is equal to the voltage at the terminal 108 (e.g., VDD) of the control chip 120 (e.g., the supply voltage for the control chip 120). The supply capacitor 174 includes another terminal biased to the system ground.

When the voltage at the terminal 108 (e.g., VDD) of the control chip 120 (e.g., the supply voltage for the control chip 120) exceeds a predetermined undervoltage protection threshold of the control chip 120, the control chip 120 begins the normal operation based at least in part on the voltage at the terminal 108 (e.g., VDD) of the control chip 120. The PWM control module 122 outputs a pulse-width-modulation (PWM) signal 123 to the gate driver 124. The gate driver 124 processes the PWM signal 123 to turn on and/or turn off the power switch 126, causing the GaN power switch 140 to turn on and/or turn off. Also during the normal operation, the supply capacitor 174 is charged by the auxiliary winding 154 through the diode 162, and the voltage at the terminal 108 (e.g., the supply voltage for the control chip 120) is supported by at least the auxiliary winding 154.

The switching power supply system 100 uses both the high-voltage startup unit 130 and the auxiliary winding 154 to generate the supply voltage for the control chip 120, often resulting in higher system cost and lower power supply efficiency.

Hence it is highly desirable to improve the technique for power supply systems with GaN power switches in order to reduce system cost and improve power supply efficiency.

### 4. BRIEF SUMMARY OF THE DISCLOSURE

Certain embodiments of the present disclosure are directed to circuits. More particularly, some embodiments of the disclosure provide power supply systems and control methods thereof. Merely by way of example, some embodiments of the disclosure have been applied to power supply systems with gallium nitride (GaN) switches. But it would be recognized that the disclosure has a much broader range of applicability.

According to certain embodiments, a control chip for a power supply system with a GaN switch includes: a first terminal connected to the GaN switch; a second terminal connected to a supply capacitor, the supply capacitor being configured to provide a supply voltage to the second terminal; a supply transistor connected between the second terminal and the first terminal; and a driver control module configured to generate a supply control signal to turn on the supply transistor and further configured to generate the supply control signal to turn off the supply transistor; wherein the control chip is configured to: in response to the supply transistor being turned on, allow a charging current to flow from the first terminal through the second terminal to charge the supply capacitor; and in response to the supply transistor being turned off, not allow any charging current to flow from the first terminal through the second terminal.

According to some embodiments, a control chip for a power supply system with a GaN switch includes: a first terminal connected to the GaN switch; a second terminal connected to a supply capacitor, the supply capacitor being configured to provide a supply voltage to the second terminal; a third terminal connected to a current sensing resistor; a supply transistor connected between the second terminal and the first terminal through a diode; a first switch connected between the first terminal and the third terminal; and a driver control module configured to: generate a supply control signal to turn on the supply transistor and turn off the supply transistor; and generate a first control signal to close and open the first switch; wherein the control chip is configured to: in response to the supply transistor being turned on, allow a charging current to flow from the first terminal through the second terminal to charge the supply capacitor; and in response to the supply transistor being turned off, not allow any charging current to flow from the first terminal through the second terminal; wherein the control chip is further configured to: in response to the first switch being closed, allow a sensing current to flow from the first terminal through the third terminal to the current sensing resistor to generate a sensing voltage; and in response to the first switch being open, not allow any sensing current to flow from the first terminal through the third terminal to the current sensing resistor.

According to certain embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to: in response to at least a rising edge of the PWM signal, change the supply control signal from the second voltage level to the first voltage level to start charging the supply capacitor.

According to some embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to, at a rising edge of the PWM signal: compare the supply voltage with a predetermined charging threshold; and if the supply voltage is smaller than the predetermined charging threshold, change the supply control signal from the second voltage level to the first voltage level to start charging the supply capacitor.

According to certain embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to: in response to at least a falling edge of the PWM signal, change the supply control signal from the second voltage level to the first voltage level to start charging the supply capacitor.

According to some embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to, at a falling edge of the PWM signal: compare the supply voltage with a predetermined charging threshold; and if the supply voltage is smaller than the predetermined charging threshold, change the supply control signal from the second voltage level to the first voltage level to start charging the supply capacitor.

Depending upon embodiment, one or more benefits may be achieved. These benefits and various additional objects, features and advantages of the present disclosure can be fully appreciated with reference to the detailed description and accompanying drawings that follow.

### 5. BRIEF DESCRIPTION OF THE DRAWINGS

FIG. 1 is a simplified diagram showing a conventional switching power supply system with a GaN power switch.

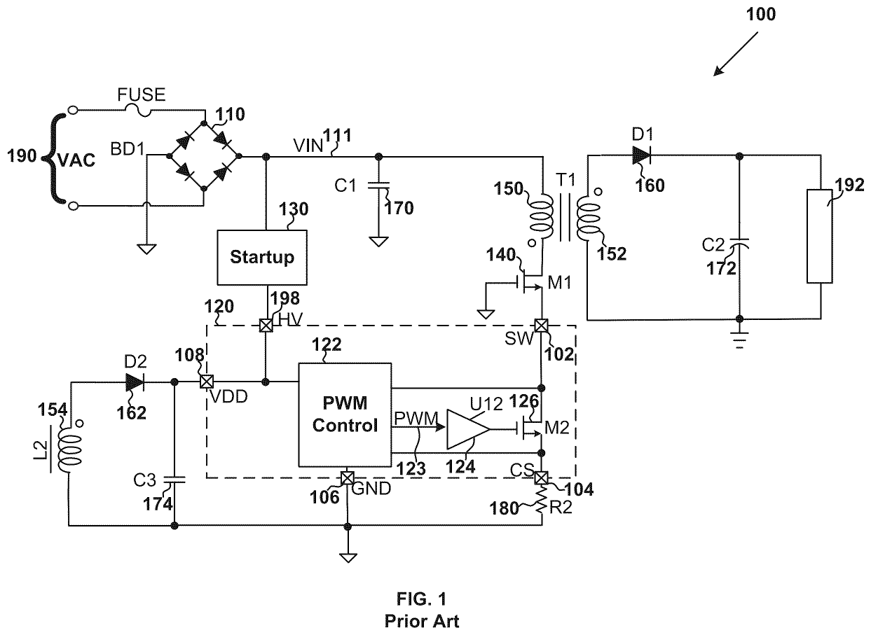

FIG. 2 is a simplified diagram showing a power supply system with a GaN switch according to some embodiments of the present disclosure.

FIG. 3 is a simplified diagram showing the control chip as part of the power supply system as shown in FIG. 2 according to certain embodiments of the present disclosure.

FIG. 4 is a simplified diagram showing the state control module as part of the control chip of the power supply system as shown in FIG. 2 and FIG. 3 according to some embodiments of the present disclosure.

FIG. 5 shows simplified timing diagrams for the power supply system if the load is a non-light load as shown in FIG. 2, FIG. 3 and/or FIG. 4 according to some embodiments of the present disclosure.

FIG. 6 is a simplified diagram showing certain components of the voltage detection module and the signal control module as parts of the control chip of the power supply system as shown in FIG. 2, FIG. 3 and FIG. 5 according to some embodiments of the present disclosure.

FIG. 7 shows simplified timing diagrams for the power supply system if the load is a non-light load as shown in FIG. 2, FIG. 3 and/or FIG. 4 according to some embodiments of the present disclosure.

FIG. 8 shows simplified timing diagrams for the power supply system if the load is a non-light load as shown in FIG. 2, FIG. 3 and/or FIG. 4 according to some embodiments of the present disclosure.

FIG. 9 is a simplified diagram showing certain components of the voltage detection module and the signal control module as parts of the control chip of the power supply system as shown in FIG. 2, FIG. 3 and FIG. 8 according to some embodiments of the present disclosure.

FIG. 10 shows simplified timing diagrams for the power supply system 200 if the load is a non-light load as shown in FIG. 2, FIG. 3 and/or FIG. 4 according to some embodiments of the present disclosure.

FIG. 11 shows simplified timing diagrams for the power supply system 200 if the load is a light load as shown in FIG. 2, FIG. 3 and/or FIG. 4 according to some embodiments of the present disclosure.

FIG. 12 is a simplified diagram showing a power supply system with a GaN switch according to some embodiments of the present disclosure.

FIG. 13 shows simplified timing diagrams for the power supply system 1200 if the load is a non-light load as shown in FIG. 12 according to some embodiments of the present disclosure.

FIG. 14 is a simplified diagram showing a power supply system with a GaN switch according to some embodiments of the present disclosure.

FIG. 15 is a simplified diagram showing a power supply system with a GaN switch according to some embodiments of the present disclosure.

FIG. 16 is a simplified diagram showing a power supply system with a GaN switch according to some embodiments of the present disclosure.

FIG. 17 is a simplified diagram showing a power supply system with a GaN switch according to some embodiments of the present disclosure.

FIG. 18 is a simplified diagram showing the control chip that includes a bipolar transistor as part of a power supply system according to certain embodiments of the present disclosure.

FIG. 19 is a simplified diagram showing the state control module as part of the control chip of the power supply system as shown in FIG. 18 according to some embodiments of the present disclosure.

### 6. DETAILED DESCRIPTION OF THE DISCLOSURE

Certain embodiments of the present disclosure are directed to circuits. More particularly, some embodiments of the disclosure provide power supply systems and control methods thereof. Merely by way of example, some embodiments of the disclosure have been applied to power supply systems with gallium nitride (GaN) switches. But it would be recognized that the disclosure has a much broader range of applicability.

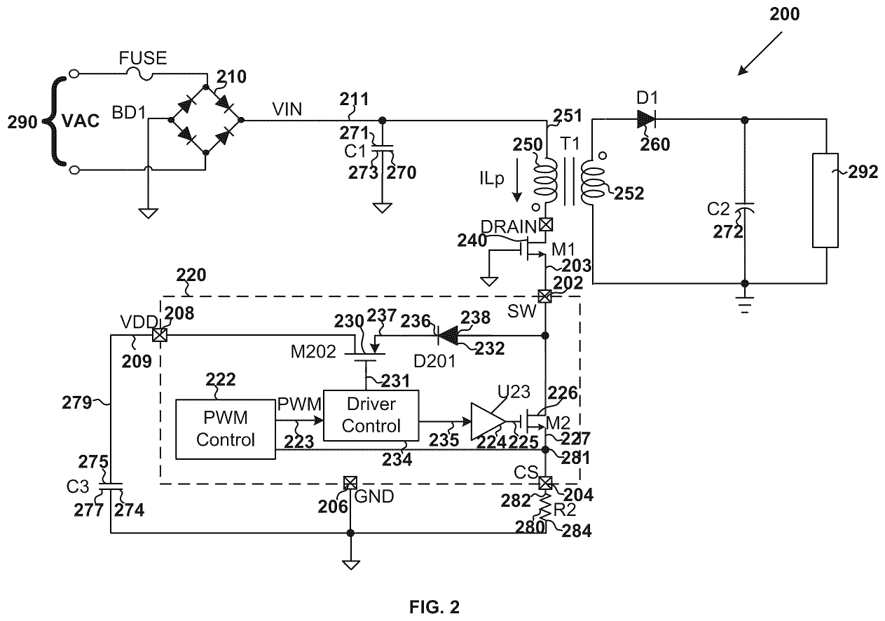

FIG. 2 is a simplified diagram showing a power supply system with a GaN switch according to some embodiments of the present disclosure. This diagram is merely an example, which should not unduly limit the scope of the claims. One of ordinary skill in the art would recognize many variations, alternatives, and modifications. The power supply system 200 (e.g., a switching power supply system) includes a full-wave rectifier 210, a control chip 220, a GaN switch 240 (e.g., a GaN power switch), a transformer that includes a primary winding 250 and a secondary winding 252, a diode 260, an input capacitor 270, an output capacitor 272, a supply capacitor 274, and a current sensing resistor 280. The control chip 220 includes a terminal 202 (e.g., SW), a terminal 204 (e.g., CS), a terminal 206 (e.g., GND), and a terminal 208 (e.g., VDD). Additionally, the control chip 220 includes a pulse-width-modulation (PWM) control module 222, a gate driver 224, a switch 226 (e.g., a power switch), a transistor 230 (e.g., a supply transistor), a diode 232, and a driver control module 234. As an example, the power supply system 200 (e.g., a switching power supply system) is used to provide power to a load 292, wherein the load 292 is configured to receive the power from the power supply system 200 (e.g., a switching power supply system). For example, the power supply system 200 (e.g., a switching power supply system) implements a flyback architecture. As an example, the GaN switch 240 (e.g., a GaN power switch) is a GaN transistor. For example, the power switch 226 (e.g., a transistor) is an NMOS transistor. Although the above has been shown using a selected group of components for the power supply system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the power supply system 200 receives an AC voltage 290. In certain examples, the full-wave rectifier 210 rectifies the AC voltage 290 to generate a voltage 211. For example, the voltage 211 is received by a terminal 271 of the input capacitor 270, which also includes a terminal 273 biased to a system ground of the power supply system 200. As an example, the voltage 211 is received by the primary winding 250, which is coupled to the secondary winding 252.

In some embodiments, the supply capacitor 274 is configured to provide a supply voltage for the control chip 220. In certain examples, a terminal 275 of the supply capacitor 274 is connected to the terminal 208 (e.g., VDD) of the control chip 220, and the voltage at the terminal 275 of the supply capacitor 274 is equal to a voltage 209 at the terminal 208 (e.g., VDD) of the control chip 220. For example, the supply capacitor 274 also includes a terminal 277 biased to the system ground. As an example, the voltage 209 at the terminal 208 (e.g., VDD) serves as the supply voltage for the control chip 220.

In certain embodiments, the power switch 226 is connected between the terminal 202 (e.g., SW) of the control chip 220 and the terminal 204 (e.g., CS) of the control chip 220. For example, the GaN switch 240 is connected between the terminal 202 (e.g., SW) of the control chip 220 and the primary winding 250. As an example, the transistor 230 is connected between the terminal 208 (e.g., VDD) and a terminal 236 of the diode 232, and the diode 232 also includes a terminal 238 connected to the terminal 202 (e.g., SW) of the control chip 220. For example, the terminal 236 of the diode 232 is biased at a voltage 237. In some examples, the terminal 204 (e.g., CS) of the control chip 220 is connected to a terminal 282 of the current sensing resistor 280, which also includes a terminal 284 biased to the system ground. In certain examples, the terminal 206 (e.g., GND) is biased to the system ground.

In some examples, if the GaN switch 240 is closed, when the power switch 226 is closed and the transistor 230 is turned off, a primary current 251 flows through the primary winding 250 to provide a sensing current 227. For example, the primary current 251 flows through the primary winding 250, the GaN switch 240 and the power switch 226 to serve as the sensing current 227, and the sensing current 227 is equal to the primary current 251 in magnitude. As an example, the sensing current 227 flows through the current sensing resistor 280 to generate a sensing voltage 281, which is received by the PWM control module 222, wherein the sensing voltage 281 represents the primary current 251 if the GaN switch 240 is closed, the power switch 226 is closed, and the transistor 230 is turned off.

In certain examples, if the GaN switch 240 is closed, when the power switch 226 is open and the transistor 230 is turned on, the primary current 251 flows through the primary winding 250 to provide a charging current 279 for the supply capacitor 274. For example, the primary current 251 flows through the primary winding 250, the GaN switch 240, the diode 232 and the transistor 230 to serve as the charging current 279, and the charging current 279 is equal to the primary current 251 in magnitude. As an example, the charging current 279 flows through the transistor 230 to charge the supply capacitor 274, causing the voltage 209 at the terminal 208 (e.g., VDD) to rise.

According to certain embodiments, the PWM control module 222 generates a pulse-width-modulation (PWM) signal 223 based at least in part on the sensing voltage 281, and the PWM control module 222 outputs the PWM signal 223 to the driver control module 234. In some examples, the driver control module 234 generates control signals 231 and 235 based at least in part on the PWM signal 223. For example, the control signal 231 (e.g., a supply control signal) is received by the transistor 230 (e.g., a supply transistor) to turn on and/or turn off the transistor 230. In certain examples, the control signal 235 is received by the gate driver 224, and the gate driver 224 generates a drive signal 225 based at least in part on the control signal 235. For example, if the control signal 235 is at a logic high level, the drive signal 225 is also at the logic high level. For example, if the control signal 235 is at a logic low level, the drive signal 225 is also at the logic low level. In some examples, the gate driver 224 outputs the drive signal 225 to close (e.g., turn on) and/or open (e.g., turn off) the power switch 226 (e.g., a transistor). For example, if the control signal 235 is at the logic high level, the drive signal 225 is at the logic high level and the power switch 226 (e.g., a transistor) is closed (e.g., turned on). As an example, if the control signal 235 is at the logic low level, the drive signal 225 is at the logic low level and the power switch 226 (e.g., a transistor) is open (e.g., turned off). In certain example, the closing and/or opening of the power switch 226 causes the GaN switch 240 to close and/or open.

In some embodiments, the transistor 230 is a MOS transistor (e.g., a PMOS transistor). In certain examples, the PMOS transistor 230 is turned off based at least in part on the control signal 231. In some examples, the PMOS transistor 230 is turned on based at least in part on the control signal 231. For example, the PMOS transistor 230 is turned on, operating in a saturation region based at least in part on the control signal 231. As an example, the PMOS transistor 230 is turned on, operating in a linear region based at least in part on the control signal 231.

In certain embodiments, the control signal 231 is used to control the operation of the PMOS transistor 230 in order to adjust the charging current 279. For example, if the PMOS transistor 230 is turned off, the charging current 279 is equal to zero in magnitude. As an example, if the PMOS transistor 230 is turned on, the charging current 279 is used to charge the supply capacitor 274, wherein the magnitude of the charging current 279 depends at least in part on whether the PMOS transistor 230 operates in the saturation region or in the linear region.

As shown in FIG. 2, after the power supply system 200 receives the AC voltage 290, the control chip 220 enters its power-up according to certain embodiments. For example, during the power-up, the GaN switch 240 is closed, the power switch 226 is open, and the transistor 230 is turned on (e.g., operating in the saturation region). As an example, during the power-up, the primary current 251 flows through the primary winding 250 to provide the charging current 279 for the supply capacitor 274. In some examples, during the power-up, the charging current 279 flows through the transistor 230 to charge the supply capacitor 274 and causes the voltage 209 at the terminal 208 (e.g., VDD) to rise. In certain examples, the voltage 209 at the terminal 208 (e.g., VDD) serves as the supply voltage for the control chip 220.

In some embodiments, if the voltage 209 at the terminal 208 (e.g., VDD) of the control chip 220 becomes larger than a predetermined undervoltage protection threshold of the control chip 220, the control chip 220 turns off the transistor 230, completes the power-up, and starts its normal operation. In certain examples, during the normal operation, the control chip 220 determines a load state of the load 292 (e.g., a light load and/or a non-light load). For example, during the normal operation, the control chip 220 determines whether the load 292 is a light load or a non-light load. As an example, the non-light load is a normal load and/or a high load (e.g., a full load). In some examples, the load state of the load 292 is the load 292 being a light load and/or the load 292 being a non-light load.

In some examples, during the normal operation, based at least in part on the load state of the load 292 and the PWM signal 223, the control chip 220 turns on and/or turns off the power switch 226 and also turns on and/or turns off the transistor 230. For example, if the control chip 220 determines to turn on the transistor 230, the control chip 220 also determines whether the transistor 230 needs to operate in the saturation region or the linear region. In some examples, during the normal operation of the control chip 220, based at least in part on the voltage 209 of the terminal 208 (e.g., VDD), the load state of the load 292, and/or the PWM signal 223, the driver control module 234 of the control chip 220 determines whether to turn on or turn off the power switch 226 and also determines whether to turn off the transistor 230, turn on the transistor 230 to operate the saturation region, or turn on the transistor 230 to operate the linear region. As an example, during the normal operation of the control chip 220, based at least in part on the voltage 209 of the terminal 208 (e.g., VDD), the load state of the load 292 (e.g., a light load and/or a non-light load), and/or the PWM signal 223, the driver control module 234 of the control chip 220 generates the control signal 231 and/or the control signal 235.

In certain embodiments, the control chip 220 determines whether the load 292 is a light load or a non-light load based at least in part on the primary current 251 (e.g., the peak value of the primary current 251). For example, the peak value of the primary current 251 is represented by the peak value of the sensing voltage 281. In some examples, the PWM control module 222 of the control chip 220 determines whether the load 292 is a light load or a non-light load based at least in part on the peak value of the sensing voltage 281. In certain examples, the driver control module 234 of the control chip 220 determines whether the load 292 is a light load or a non-light load based at least in part on the peak value of the sensing voltage 281.

According to some embodiments, the diode 232 is used to prevent any current from flowing from the terminal 275 of the supply capacitor 274 to the terminal 202 (e.g., SW) of the control chip 220 when a voltage 203 of the terminal 202 (e.g., SW) is lower than the voltage 209 of the terminal 208 (e.g., VDD).

According to certain embodiments, the primary current 251 flows through the primary winding 250, the GaN switch 240, the diode 232 and the transistor 230 to serve as the charging current 279, and the charging current 279 is equal to the primary current 251 in magnitude. In some examples, the charging path for the supply capacitor 274 includes the primary winding 250, the GaN switch 240, the diode 232, and the transistor 230. In certain examples, between the terminal 202 (e.g., SW) and the terminal 208 (e.g., VDD) of the control chip 220, the transistor 230 is the only transistor on the charging path for the supply capacitor 274. For example, if the transistor 230 is turned off, the charging path is disconnected. As an example, in order to charge the supply capacitor 274, the transistor 230 must be turned on.

As mentioned above and further emphasized here, FIG. 2 is merely an example, which should not unduly limit the scope of the claims. One of ordinary skill in the art would recognize many variations, alternatives, and modifications. For example, the diode 232 is placed between the transistor 230 and the supply capacitor 274, wherein the terminal 236 is connected to the supply capacitor 274 and the terminal 238 is connected to the transistor 230. As an example, the diode 232 is replaced by a different type of unidirectional conductive device that prevents any current from flowing from the terminal 275 of the supply capacitor 274 to the terminal 202 (e.g., SW) of the control chip 220 when the voltage of the terminal 202 (e.g., SW) is lower than the voltage 209 of the terminal 208 (e.g., VDD).

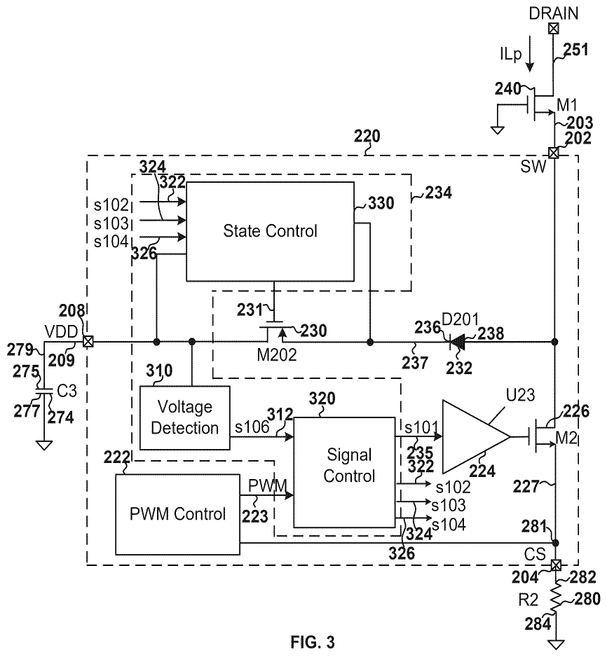

FIG. 3 is a simplified diagram showing the control chip 220 as part of the power supply system 200 as shown in FIG. 2 according to certain embodiments of the present disclosure. This diagram is merely an example, which should not unduly limit the scope of the claims. One of ordinary skill in the art would recognize many variations, alternatives, and modifications. The control chip 220 includes the PWM control module 222, the gate driver 224, the switch 226 (e.g., a power switch), the transistor 230, the diode 232, and the driver control module 234, and the driver control module 234 includes a voltage detection module 310, a signal control module 320, and a state control module 330. Although the above has been shown using a selected group of components for the control chip 220, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In some embodiments, the voltage detection module 310 is configured to detect the voltage 209 of the terminal 208 (e.g., VDD) and generate a detection signal 312 based at least in part on the voltage 209. For example, the detection signal 312 represents the magnitude of the voltage 209. As an example, the detection signal 312 is received by the signal control module 320. In certain examples, the signal control module 320 determines whether the voltage 209 exceeds the predetermined undervoltage protection threshold of the control chip 220 based at least in part on the detection signal 312. For example, the signal control module 320 determines that the voltage 209 does not exceed the predetermined undervoltage protection threshold and that the control chip 220 is in the power-up process. As an example, the signal control module 320 determines that the voltage 209 exceeds the predetermined undervoltage protection threshold and that the control chip 220 is in normal operation. In some examples, based at least in part on whether the control chip 220 is in the power-up process or in normal operation, the signal control module 320 generates the control signal 235 and also control signals 322, 324 and 326. For example, the signal control module 320 sends the control signal 235 to the gate driver 224. As an example, the signal control module 320 sends the control signals 322, 324 and 326 to the state control module 330.

In certain embodiments, based at least in part on the control signals 322, 324 and 326, the state control module 330 generates the control signal 231. For example, the control signal 231 is a voltage. As an example, the state control module 330 sends the voltage 231 to the transistor 230, and the voltage 231 serves as a gate voltage of the transistor 230. In some examples, based at least in part on the control signals 322, 324 and 326, the state control module 330 adjusts the gate voltage 231 of the transistor 230 to control the state of the transistor 230. For example, the state of the transistor 230 is that the transistor 230 is turned off. As an example, the state of the transistor 230 is that the transistor 230 is turned on, operating in the saturation region. For example, the state of the transistor 230 is that the transistor 230 is turned on, operating in the linear region.

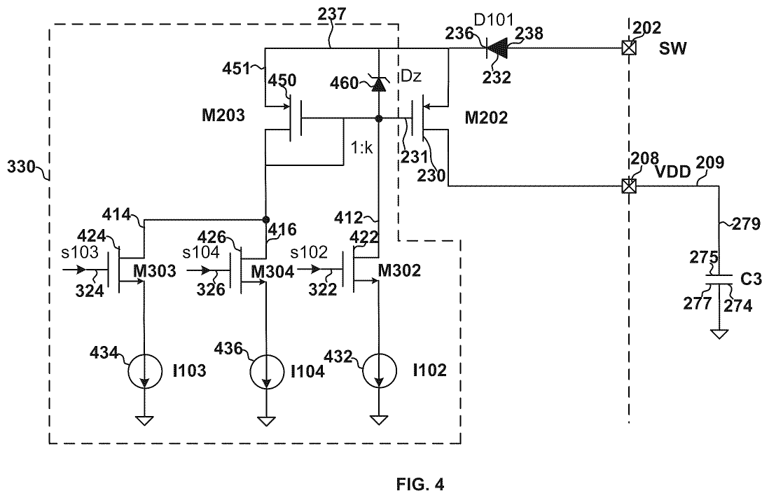

FIG. 4 is a simplified diagram showing the state control module 330 as part of the control chip 220 of the power supply system 200 as shown in FIG. 2 and FIG. 3 according to some embodiments of the present disclosure. This diagram is merely an example, which should not unduly limit the scope of the claims. One of ordinary skill in the art would recognize many variations, alternatives, and modifications. The state control module 330 includes control switches 422, 424 and 426, bias current sources 432, 434 and 436, a transistor 450 (e.g., a MOS transistor), and a Zener diode 460. Although the above has been shown using a selected group of components for the state control module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain embodiments, a gate terminal of the transistor 450 (e.g., a PMOS transistor) is connected to a gate terminal of the transistor 230, a source terminal of the transistor 450 (e.g., a PMOS transistor) is connected to a source terminal of the transistor 230, and a drain terminal of the transistor 450 (e.g., a PMOS transistor) is connected to the gate terminal of the transistor 450. For example, the control switch 422 (e.g., a transistor) is connected between the bias current source 432 and the transistor 450 (e.g., the drain terminal of the transistor 450), the control switch 424 (e.g., a transistor) is connected between the bias current source 434 and the transistor 450 (e.g., the drain terminal of the transistor 450), and the control switch 426 (e.g., a transistor) is connected between the bias current source 436 and the transistor 450 (e.g., the drain terminal of the transistor 450). As an example, the gate terminal of the transistor 450 and the gate terminal of the transistor 230 are both connected to the terminal 236 of the diode 232 and biased to the voltage 237.

In some embodiments, the control signal 322 is received by the control switch 422 to close (e.g., turn on) and/or open (e.g., turn off) the control switch 422 (e.g., a transistor), the control signal 324 is received by the control switch 424 to close (e.g., turn on) and/or open (e.g., turn off) the control switch 424 (e.g., a transistor), and the control signal 326 is received by the control switch 426 to close (e.g., turn on) and/or open (e.g., turn off) the control switch 426 (e.g., a transistor). For example, if the control signal 322 is at a logic high level, the control switch 422 (e.g., a transistor) is closed (e.g., turned on), and if the control signal 322 is at a logic low level, the control switch 422 (e.g., a transistor) is open (e.g., turned off). As an example, if the control signal 324 is at the logic high level, the control switch 424 (e.g., a transistor) is closed (e.g., turned on), and if the control signal 324 is at the logic low level, the control switch 424 (e.g., a transistor) is open (e.g., turned off). For example, if the control signal 326 is at the logic high level, the control switch 426 (e.g., a transistor) is closed (e.g., turned on), and if the control signal 326 is at the logic low level, the control switch 426 (e.g., a transistor) is open (e.g., turned off). In certain examples, the bias current source 432 is configured to generate a bias current 412 if the control switch 422 is closed, the bias current source 434 is configured to generate a bias current 414 if the control switch 424 is closed, and the bias current source 436 is configured to generate a bias current 416 if the control switch 426 is closed. In some examples, the bias current 412 is equal to zero if the control switch 422 is open, the bias current 414 is equal to zero if the control switch 424 is open, and the bias current 416 is equal to zero if the control switch 426 is open.

According to certain embodiments, a current 451 that flows from the source terminal of the transistor 450 to the drain terminal of the transistor 450 is equal to a sum of the bias current 412, the bias current 414, and the bias current 416. For example, the bias current 412 is larger than zero or equal to zero in magnitude. As an example, the bias current 414 is larger than zero or equal to zero in magnitude. For example, the bias current 416 is larger than zero or equal to zero in magnitude.

According to some embodiments, the Zener diode 460 is connected between the source terminal of the transistor 450 and the gate terminal of the transistor 450, and the Zener diode 460 is also connected between the source terminal of the transistor 230 and the gate terminal of the transistor 230. For example, the Zener diode 460 provides voltage clamp protection for the transistor 450. As an example, the Zener diode 460 provides voltage clamp protection for the transistor 230.

In certain embodiments, the transistor 450 is connected to the transistor 230 to form a current mirror. For example, a current that flows from the source terminal of the transistor 230 to the drain terminal of the transistor 230 is equal to the current 451 multiplied by a mirror ratio (e.g., k). In some examples, the transistor 450 is used to mirror the current 451 to set the gate voltage 231 of the transistor 230, and the gate voltage 231 of the transistor 230 is used to control the state of the transistor 230. In certain examples, the transistor 230 is a PMOS transistor. For example, if the gate voltage 231 is at a high voltage level, the PMOS transistor 230 is turned off. As an example, if the gate voltage 231 is at a low voltage level, the PMOS transistor 230 is turned on, operating in the saturation region or in the linear region.

In some examples, if the control switch 422 (e.g., a transistor) is open (e.g., turned off), the control switch 424 (e.g., a transistor) is open (e.g., turned off), and the control switch 426 (e.g., a transistor) is open (e.g., turned off), the gate voltage 231 is at the high voltage level and the PMOS transistor 230 is turned off. In certain examples, if the control switch 422 (e.g., a transistor) is closed (e.g., turned on), the control switch 424 (e.g., a transistor) is open (e.g., turned off), and the control switch 426 (e.g., a transistor) is open (e.g., turned off), the gate voltage 231 is at a low voltage level and the PMOS transistor 230 is turned on, operating in the linear region. For example, if the control switch 422 (e.g., a transistor) is closed (e.g., turned on), the control switch 424 (e.g., a transistor) is open (e.g., turned off), and the control switch 426 (e.g., a transistor) is open (e.g., turned off), the gate voltage 231 of the transistor 230 is equal to the voltage 237 minus a breakdown voltage (e.g., V₀) of the Zener diode 460. As an example, if the control switch 422 (e.g., a transistor) is closed (e.g., turned on), the control switch 424 (e.g., a transistor) is open (e.g., turned off), and the control switch 426 (e.g., a transistor) is open (e.g., turned off), the charging current 279 that flows through the transistor 230 is determined by at least the drain-source voltage of the transistor 230 and the on-resistance (e.g., Rₒₙ) of the transistor 230.

In some examples, if the control switch 422 (e.g., a transistor) is open (e.g., turned off), the control switch 424 (e.g., a transistor) is closed (e.g., turned on), and the control switch 426 (e.g., a transistor) is open (e.g., turned off), the gate voltage 231 is at a low voltage level and the PMOS transistor 230 is turned on, operating in the saturation region. As an example, if the control switch 422 (e.g., a transistor) is open (e.g., turned off), the control switch 424 (e.g., a transistor) is closed (e.g., turned on), and the control switch 426 (e.g., a transistor) is open (e.g., turned off), the charging current 279 that flows through the transistor 230 is equal to the bias current 414 multiplied by the mirror ratio (e.g., k). In certain examples, if the control switch 422 (e.g., a transistor) is open (e.g., turned off), the control switch 424 (e.g., a transistor) is open (e.g., turned off), and the control switch 426 (e.g., a transistor) is closed (e.g., turned on), the gate voltage 231 is at a low voltage level and the PMOS transistor 230 is turned on, operating in the saturation region. For example, if the control switch 422 (e.g., a transistor) is open (e.g., turned off), the control switch 424 (e.g., a transistor) is open (e.g., turned off), and the control switch 426 (e.g., a transistor) is closed (e.g., turned on), the charging current 279 that flows through the transistor 230 is equal to the bias current 416 multiplied by the mirror ratio (e.g., k).

In some embodiments, during the normal operation, the control chip 220 determines whether the load 292 is a light load or a non-light load, and the driver control module 234 implements different control mechanisms corresponding to the load 292 being a light load or a non-light load respectively. In certain examples, during the normal operation of the control chip 220, if the load 292 is a light load, when the PWM signal 223 is at the logic low level, the driver control module 234 is configured to turn on the transistor 230 to operate in the saturation region and open (e.g., turn off) the switch 226 (e.g., a transistor), but when the PWM signal 223 is at a logic high level, the driver control module 234 is configured to turn off the transistor 230 and close (e.g., turn on) the switch 226 (e.g., a transistor).

In some examples, during the normal operation of the control chip 220, if the load 292 is a non-light load, the driver control module 234 is configured to, based at least in part on the voltage 209 of the terminal 208 (e.g., VDD) and a rising edge and/or a falling edge of the PWM signal 223, turn on the transistor 230 to operate in the linear region and/or turn off the transistor 230, and the driver control module 234 is configured to close (e.g., turn on) the switch 226 (e.g., a transistor) if the PWM signal 223 is at a logic high level and the transistor 230 is turned off and is also configured to open (e.g., turn off) the switch 226 (e.g., a transistor) if the PWM signal 223 is at a logic low level and/or the transistor 230 is turned on. For example, during the normal operation of the control chip 220, if the load 292 is a non-light load, the driver control module 234 is configured to, based at least in part on the voltage 209 of the terminal 208 (e.g., VDD) and a rising edge of the PWM signal 223, turn on the transistor 230 to operate in the linear region and/or turn off the transistor 230. As an example, during the normal operation of the control chip 220, if the load 292 is a non-light load, the driver control module 234 is configured to, based at least in part on the voltage 209 of the terminal 208 (e.g., VDD) and a falling edge of the PWM signal 223, turn on the transistor 230 to operate in the linear region and/or turn off the transistor 230.

According to certain embodiments, during the normal operation of the control chip 220, if the load 292 is a non-light load, when the transistor 230 is turned on (e.g., operating in the linear region), the supply capacitor 274 is charged by the charging current 279 for a charging duration to raise the voltage 209 of the terminal 208 (e.g., VDD), and the charging duration ends when the transistor 230 becomes turned off and therefore the charging of the supply capacitor 274 stops.

In some examples, the charging duration starts at a rising edge and/or a falling edge of the PWM signal 223 without making a comparison between the voltage 209 and a predetermined charging threshold, and the length of the charging duration depends at least in part on the voltage 209 at the start of the charging duration. In certain examples, if the voltage 209 at the start of the charging duration exceeds a predetermined maximum value, the length of the charging duration equals zero, and if the voltage 209 at the start of the charging duration does not exceed the predetermined maximum value, the length of the charging duration increases if the voltage 209 at the start of the charging duration decreases, wherein the predetermined maximum value is larger than the predetermined charging threshold. As an example, the length of the charging duration decreases if the voltage 209 at the start of the charging duration increases.

In some examples, the charging duration starts at a rising edge and/or a falling edge of the PWM signal 223 if the voltage 209 at the rising edge and/or the falling edge of the PWM signal 223 is compared with the predetermined charging threshold and is determined to be less than the predetermined charging threshold. For example, the length of the charging duration equals a predetermined constant.

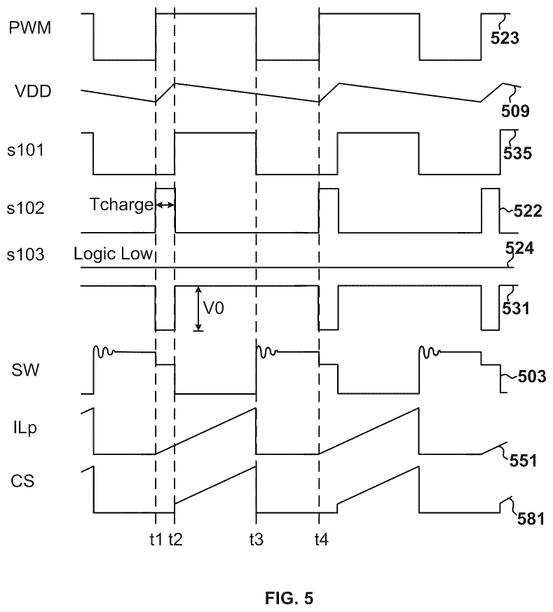

FIG. 5 shows simplified timing diagrams for the power supply system 200 if the load 292 is a non-light load as shown in FIG. 2, FIG. 3 and/or FIG. 4 according to some embodiments of the present disclosure. These diagrams are merely examples, which should not unduly limit the scope of the claims. One of ordinary skill in the art would recognize many variations, alternatives, and modifications. The waveform 523 represents the PWM signal 223 as a function of time, the waveform 509 represents the voltage 209 as a function of time, the waveform 535 represents the control signal 235 as a function of time, the waveform 522 represents the control signal 322 as a function of time, the waveform 524 represents the control signal 324 as a function of time, the waveform 531 represents the control signal 231 as a function of time, the waveform 503 represents the voltage 203 as a function of time, the waveform 551 represents the primary current 251 as a function of time, and the waveform 581 represents the sensing voltage 281 as a function of time.

As shown in FIG. 2 and FIG. 3, the transistor 230 is a PMOS transistor according to certain embodiments. In some examples, at a rising edge of the PWM signal 223, the PMOS transistor 230 becomes turned on to operate in the linear region and then remains in the linear region for a charging duration, wherein the length of the charging duration depends at least in part on the voltage 209 at a rising edge of the PWM signal 223. For example, the length of the charging duration increases if the voltage 209 at a rising edge of the PWM signal 223 decreases. As an example, the length of the charging duration decreases if the voltage 209 at a rising edge of the PWM signal 223 increases. In certain examples, the control signals 324 and 326 both remain at the logic low level.

At time t₁, the PWM signal 223 changes from a logic low level to a logic high level as shown by the waveform 523 according to some embodiments. In certain examples, at time t₁, in response to the rising edge of the PWM signal 223, the control signal 322 changes from a logic low level to a logic high level as shown by the waveform 522. For example, at time t₁, the gate voltage 231 of the transistor 230 drops from a high voltage level that equals the voltage 237 to a low voltage level that equals the voltage 237 minus the breakdown voltage (e.g., V₀) of the Zener diode 460 as shown by the waveform 531. As an example, at time t₁, in response to the gate voltage 231 dropping from the high voltage level to the low voltage level, the PMOS transistor 230 becomes turned on to operate in the linear region, causing the GaN switch 240 to become turned on. In some examples, at time t₁, the primary current 251 starts flowing through the primary winding 250, the GaN switch 240, the diode 232 and the transistor 230 to serve as the charging current 279, wherein the charging current 279 is equal to the primary current 251 in magnitude. For example, at time t₁, the charging of the supply capacitor 274 starts.

From time t₁ to time t₂, the GaN switch 240 remains turned on, and the PMOS transistor 230 remains in the linear region according to certain embodiments. In some examples, from time t₁ to time t₂, the control signal 322 remains at the logic high level as shown by the waveform 522, the control signal 324 remains at the logic low level as shown by the waveform 524, and the control signal 326 remains at the logic low level. As an example, from time t₁ to time t₂, the control signal 235 remains at the logic low level as shown by the waveform 535. In certain examples, from time t₁ to time t₂, the supply capacitor 274 is charged by the charging current 279. For example, from time t₁ to time t₂, the voltage 209 rises gradually as shown by the waveform 509. As an example, from time t₁ to time t₂, the primary current 251 increases gradually from zero as shown by the waveform 551, wherein the primary current 251 is equal to the charging current 279.

At time t₂, the control signal 322 changes from the logic high level to the logic low level as shown by the waveform 522 according to some embodiments. For example, at time t₂, the gate voltage 231 of the transistor 230 rises from the low voltage level that equals the voltage 237 minus the breakdown voltage (e.g., V₀) of the Zener diode 460 to the high voltage level that equals the voltage 237 as shown by the waveform 531. In certain examples, at time t₂, in response to the gate voltage 231 rising from the low voltage level to the high voltage level, the PMOS transistor 230 becomes turned off and the charging of the supply capacitor 274 stops. For example, the time duration from time t₁ to time t₂ is a charging duration, during which the supply capacitor 274 is charged by the charging current 279. In some examples, at time t₂, the control signal 235 changes from a logic low level to a logic high level as shown by the waveform 535, and the power switch 226 (e.g., a transistor) becomes closed (e.g., turned on). For example, at time t₂, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

From time t₂ to time t₃, the primary current 251 increases gradually as shown by the waveform 551, wherein the primary current 251 is equal to the sensing current 227 in magnitude, according to certain embodiments. In some examples, from time t₂ to time t₃, the control signal 322 remains at the logic low level as shown by the waveform 522, the control signal 324 remains at the logic low level as shown by the waveform 524, and the control signal 326 remains at the logic low level. As an example, from time t₂ to time t₃, the control signal 235 remains at the logic high level as shown by the waveform 535. In certain examples, from time t₂ to time t₃, the gate voltage 231 of the transistor 230 remains at the high voltage level that equals the voltage 237 as shown by the waveform 531. For example, from time t₂ to time t₃, the PMOS transistor 230 remains turned off. As an example, from time t₂ to time t₃, the voltage 209 decreases gradually as shown by the waveform 509.

At time t₃, the PWM signal 223 changes from the logic high level to the logic low level as shown by the waveform 523 according to some embodiments. As an example, at time t₃, the control signal 235 changes from the logic high level to the logic low level as shown by the waveform 535, and the power switch 226 (e.g., a transistor) becomes open (e.g., turned off). In certain examples, at time t₃, the control signal 322 remains at the logic low level as shown by the waveform 522, the control signal 324 remains at the logic low level as shown by the waveform 524, and the control signal 326 remains at the logic low level. For example, at time t₃, the PMOS transistor 230 remains turned off. In some examples, at time t₃, the primary current 251 drops to zero in magnitude as shown by the waveform 551.

From time t₃ to time t₄, the PWM signal 223 remains at the logic low level as shown by the waveform 523 according to certain embodiments. As an example, from time t₃ to time t₄, the control signal 235 remains at the logic low level as shown by the waveform 535, and the power switch 226 (e.g., a transistor) remains open (e.g., turned off). In certain examples, from time t₃ to time t₄, the control signal 322 remains at the logic low level as shown by the waveform 522, the control signal 324 remains at the logic low level as shown by the waveform 524, and the control signal 326 remains at the logic low level. For example, from time t₃ to time t₄, the PMOS transistor 230 remains turned off. In some examples, from time t₃ to time t₄, the primary current 251 remains equal to zero in magnitude as shown by the waveform 551. As an example, from time t₃ to time t₄, the voltage 209 decreases gradually as shown by the waveform 509.

At time t₄, the PWM signal 223 changes from the logic low level to the logic high level as shown by the waveform 523 according to some embodiments. In certain examples, at time t₄, in response to the rising edge of the PWM signal 223, the control signal 322 changes from the logic low level to the logic high level as shown by the waveform 522. For example, at time t₄, the gate voltage 231 of the transistor 230 drops from the high voltage level that equals the voltage 237 to the low voltage level that equals the voltage 237 minus the breakdown voltage (e.g., V₀) of the Zener diode 460 as shown by the waveform 531. As an example, at time t₄, in response to the gate voltage 231 dropping from the high voltage level to the low voltage level, the PMOS transistor 230 becomes turned on to operate in the linear region, causing the GaN switch 240 to become turned on. In some examples, at time t₄, the primary current 251 starts flowing through the primary winding 250, the GaN switch 240, the diode 232 and the transistor 230 to serve as the charging current 279, wherein the charging current 279 is equal to the primary current 251 in magnitude. For example, at time t₄, the charging of the supply capacitor 274 starts.

As shown in FIG. 5, the charging duration starts at the rising edge of the PWM signal 223 (e.g., at time t₁) without making a comparison between the voltage 209 and a predetermined charging threshold, and the length of the charging duration (e.g., from time t₁ to time t₂) depends at least in part on the voltage 209 at the start of the charging duration (e.g., at time t₁). In certain examples, if the voltage 209 at the start of the charging duration (e.g., at time t₁) exceeds a predetermined maximum value, the length of the charging duration (e.g., from time t₁ to time t₂) equals zero, and if the voltage 209 at the start of the charging duration (e.g., at time t₁) does not exceed the predetermined maximum value, the length of the charging duration (e.g., from time t₁ to time t₂) increases if the voltage 209 at the start of the charging duration (e.g., at time t₁) decreases, wherein the predetermined maximum value is larger than the predetermined charging threshold. As an example, the length of the charging duration (e.g., from time t₁ to time t₂) decreases if the voltage 209 at the start of the charging duration (e.g., at time t₁) increases. In some examples, if the voltage 209 at the start of the charging duration (e.g., at time t₁) exceeds the predetermined maximum value, the length of the charging duration (e.g., from time t₁ to time t₂) equals zero by setting time t₂ to be the same as time t₁. For example, at time t₁ that is equal to time t₂, the control signal 322 remains at the logic low level, the gate voltage 231 of the transistor 230 remains at the high voltage level that equals the voltage 237, the PMOS transistor 230 remains turned off, and the supply capacitor 274 is not being charged.

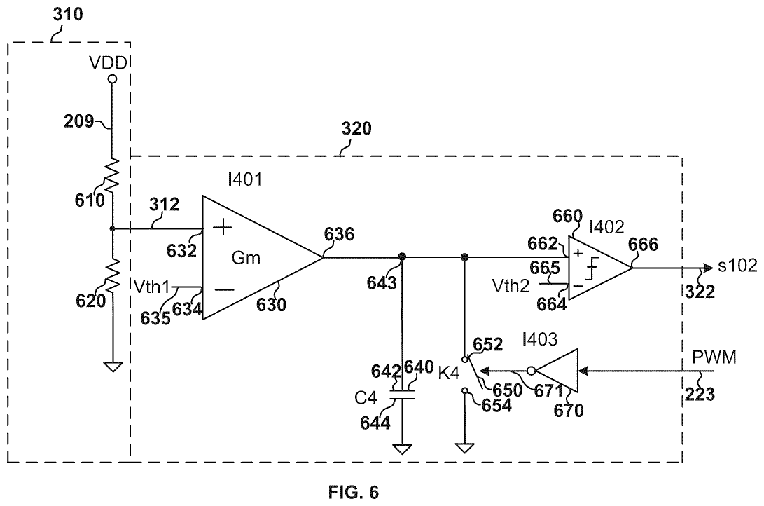

FIG. 6 is a simplified diagram showing certain components of the voltage detection module 310 and the signal control module 320 as parts of the control chip 220 of the power supply system 200 as shown in FIG. 2, FIG. 3 and FIG. 5 according to some embodiments of the present disclosure. This diagram is merely an example, which should not unduly limit the scope of the claims. One of ordinary skill in the art would recognize many variations, alternatives, and modifications. The voltage detection module 310 includes resistors 610 and 620, and the signal control module 320 includes a transconductance amplifier 630, a capacitor 640, a switch 650, a comparator 660, and an inverter 670 (e.g., a NOT gate). Although the above has been shown using a selected group of components for the voltage detection module and the signal control module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the components of the voltage detection module 310 and the signal control module 320 as shown in FIG. 6 are used to implement the control mechanism as shown in FIG. 5. In some examples, as shown in FIG. 5, if the voltage 209 at the start of the charging duration (e.g., at time t₁) decreases, the length of the charging duration (e.g., from time t₁ to time t₂) increases, and if the voltage 209 at the start of the charging duration (e.g., at time t₁) increases, the length of the charging duration (e.g., from time t₁ to time t₂) decreases. In certain examples, the resistors 610 and 620 are connected in series to form a voltage divider, which is biased between the voltage 209 of the terminal 208 (e.g., VDD) and the system ground to generate the detection signal 312, wherein the detection signal 312 represents the magnitude of the voltage 209.

According to some embodiments, the transconductance amplifier 630 includes an input terminal 632 (e.g., a non-inverting input terminal), an input terminal 634 (e.g., an inverting input terminal), and an output terminal 636. For example, the input terminal 632 (e.g., a non-inverting input terminal) receives the detection signal 312. As an example, the input terminal 634 (e.g., an inverting input terminal) receives a threshold voltage 635 (e.g., Vₜₕ₁). In certain examples, the capacitor 640 includes terminals 642 and 644, and the switch 650 includes terminals 652 and 654. In some examples, the comparator 660 includes an input terminal 662 (e.g., a non-inverting input terminal), an input terminal 664 (e.g., an inverting input terminal), and an output terminal 666. For example, the output terminal 636 of the transconductance amplifier 630 is connected to the terminal 642 of the capacitor 640, the terminal 652 of the switch 650, and the input terminal 662 (e.g., a non-inverting input terminal) of the comparator 660. As an example, the terminal 644 of the capacitor 640 and the terminal 654 of the switch 650 both are biased to the system ground.

In certain embodiments, the inverter 670 (e.g., a NOT gate) receives the PWM signal 223 and generates a control signal 671. For example, if the PWM signal 223 is at the logic high level, the control signal 671 is at the logic low level. As an example, if the PWM signal 223 is at the logic low level, the control signal 671 is at the logic high level. In some examples, the control signal 671 is used to open and/or close the switch 650. For example, if the control signal 671 is at the logic low level, the switch 650 is open. As an example, if the control signal 671 is at the logic high level, the switch 650 is closed.

In some embodiments, the input terminal 662 (e.g., a non-inverting input terminal) of the comparator 660 is biased to a voltage 643 at the terminal 642 of the capacitor 640, and the input terminal 664 (e.g., an inverting input terminal) of the comparator 660 receives a threshold voltage 665 (e.g., Vₜₕ₂). In certain examples, the comparator 660 compares the voltage 643 and the threshold voltage 665 (e.g., Vₜₕ₂) and generates the control signal 322. For example, the control signal 322 changes from the logic low level to the logic high level, remains at the logic high level, and then changes from the logic high level back to the logic low level to form a pulse (e.g., as shown by the waveform 522 of FIG. 5). As an example, the pulse width of the control signal 322 is equal to the charging duration (e.g., the time duration from time t₁ to time t₂ as shown in FIG. 5).

According to certain embodiments, the pulse width of the control signal 322 (e.g., the charging duration) is determined as follows:

$${T}_{c h a r g e} = \frac{{C}_{4} \times {V}_{t h 2}}{{g}_{m} \times ( \frac{{V}_{D D} \times {R}_{b}}{{R}_{a} + {R}_{b}} {V}_{t h 1} )} \qquad ( Equation l )$$

where T_{charge} represents the pulse width of the control signal 322 (e.g., the charging duration). Additionally, Rₐ represents the resistance of the resistor 610, and R_{b} represents the resistance of the resistor 620. Moreover, Vₜₕ₁ represents the threshold voltage 635, and Vₜₕ₂ represents the threshold voltage 665. Also, VDD represents the voltage 209 at the terminal 208 (e.g., the supply voltage for the control chip 220). Additionally, C₄ represents the capacitance of the capacitor 640, and gₘ represents the transconductance coefficient of the transconductance amplifier 630.

According to some embodiments, as shown in FIG. 5, if the voltage 209 (e.g., V_{DD}) at the start of the charging duration (e.g., at time t₁) decreases, the charging duration (e.g., from time t₁ to time t₂) increases, and if the voltage 209 (e.g., V_{DD}) at the start of the charging duration (e.g., at time t₁) increases, the charging duration (e.g., from time t₁ to time t₂) decreases. For example, the charging duration (e.g., from time t₁ to time t₂) depends at least in part on the voltage 209 (e.g., V_{DD}) at a rising edge of the PWM signal 223 (e.g., at time t₁ as shown by the waveform 523).

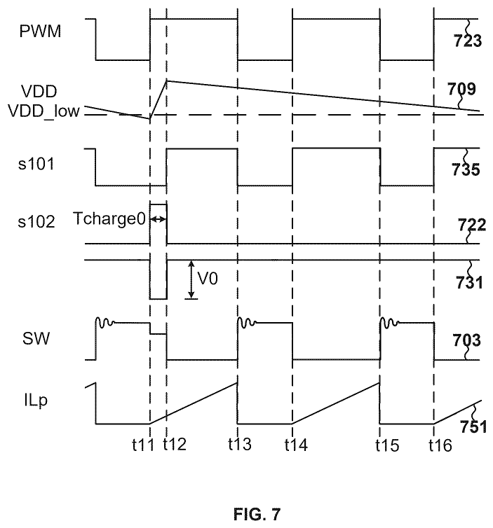

FIG. 7 shows simplified timing diagrams for the power supply system 200 if the load 292 is a non-light load as shown in FIG. 2, FIG. 3 and/or FIG. 4 according to some embodiments of the present disclosure. These diagrams are merely examples, which should not unduly limit the scope of the claims. One of ordinary skill in the art would recognize many variations, alternatives, and modifications. The waveform 723 represents the PWM signal 223 as a function of time, the waveform 709 represents the voltage 209 as a function of time, the waveform 735 represents the control signal 235 as a function of time, the waveform 722 represents the control signal 322 as a function of time, the waveform 731 represents the control signal 231 as a function of time, the waveform 703 represents the voltage 203 as a function of time, and the waveform 751 represents the primary current 251 as a function of time.

As shown in FIG. 2 and FIG. 3, the transistor 230 is a PMOS transistor according to certain embodiments. In some examples, at a rising edge of the PWM signal 223, if the voltage 209 is smaller than a predetermined charging threshold (e.g., V_{DD_low}), the PMOS transistor 230 becomes turned on to operate in the linear region and then remains in the linear region for a predetermined charging duration, wherein the length of the predetermined charging duration is equal to a predetermined constant (e.g., T_{charge0}). In certain examples, at a rising edge of the PWM signal 223, if the voltage 209 is not smaller than the predetermined charging threshold (e.g., V_{DD_low}), the PMOS transistor 230 remains turned off. For example, if the voltage 209 is not smaller than the predetermined charging threshold (e.g., V_{DD_low}), there is no need to charge the supply capacitor 274. In some examples, the control signals 324 and 326 both remain at the logic low level.

At time t₁₁, the PWM signal 223 changes from a logic low level to a logic high level as shown by the waveform 723 according to some embodiments. In certain examples, at time t₁₁, in response to the voltage 209 being smaller than the predetermined charging threshold (e.g., V_{DD_low}) at the rising edge of the PWM signal 223, the control signal 322 changes from a logic low level to a logic high level as shown by the waveform 722. For example, at time t₁₁, the gate voltage 231 of the transistor 230 drops from a high voltage level that equals the voltage 237 to a low voltage level that equals the voltage 237 minus the breakdown voltage (e.g., V₀) of the Zener diode 460 as shown by the waveform 731. As an example, at time t₁₁, in response to the gate voltage 231 dropping from the high voltage level to the low voltage level, the PMOS transistor 230 becomes turned on to operate in the linear region, causing the GaN switch 240 to become turned on. In some examples, at time t₁₁, the primary current 251 starts flowing through the primary winding 250, the GaN switch 240, the diode 232 and the transistor 230 to serve as the charging current 279, wherein the charging current 279 is equal to the primary current 251 in magnitude. For example, at time t₁₁, the charging of the supply capacitor 274 starts. In some examples, at the rising edge of the PWM signal 223 (e.g., at time t₁₁), the driver control module 234 (e.g., the signal control module 320) compares the voltage 209 with the predetermined charging threshold (e.g., V_{DD_low}). For example, if the voltage 209 at the rising edge of the PWM signal 223 (e.g., at time t₁₁) is smaller than the predetermined charging threshold (e.g., V_{DD_low}), the driver control module 234 (e.g., the signal control module 320) changes the control signal 322 from the logic low level to the logic high level as shown by the waveform 722 so that the gate voltage 231 of the transistor 230 drops from the high voltage level that equals the voltage 237 to the low voltage level that equals the voltage 237 minus the breakdown voltage (e.g., V₀) of the Zener diode 460 as shown by the waveform 731.

From time t₁₁ to time t₁₂, the GaN switch 240 remains turned on, and the PMOS transistor 230 remains in the linear region according to certain embodiments. In some examples, from time t₁₁ to time t₁₂, the control signal 322 remains at the logic high level as shown by the waveform 722, the control signal 324 remains at the logic low level, and the control signal 326 remains at the logic low level. As an example, from time t₁ to time t₁₂, the control signal 235 remains at the logic low level as shown by the waveform 735. In certain examples, from time t₁₁ to time t₁₂, the supply capacitor 274 is charged by the charging current 279. For example, from time t₁₁ to time t₁₂, the voltage 209 rises gradually as shown by the waveform 709. As an example, from time t₁₁ to time t₁₂, the primary current 251 increases gradually from zero as shown by the waveform 751, wherein the primary current 251 is equal to the charging current 279.

At time t₁₂, the control signal 322 changes from the logic high level to the logic low level as shown by the waveform 722 according to some embodiments. For example, at time t₁₂, the gate voltage 231 of the transistor 230 rises from the low voltage level that equals the voltage 237 minus the breakdown voltage (e.g., V₀) of the Zener diode 460 to the high voltage level that equals the voltage 237 as shown by the waveform 731. In certain examples, at time t₁₂, in response to the gate voltage 231 rising from the low voltage level to the high voltage level, the PMOS transistor 230 becomes turned off and the charging of the supply capacitor 274 stops. For example, the time duration from time t₁ to time t₁₂ is a charging duration, during which the supply capacitor 274 is charged by the charging current 279. In some examples, at time t₁₂, the control signal 235 changes from a logic low level to a logic high level as shown by the waveform 735, and the power switch 226 (e.g., a transistor) becomes closed (e.g., turned on). For example, at time t₁₂, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude. In certain examples, the charging duration (e.g., from time t₁₁ to time t₁₂) is equal to the predetermined constant (e.g., T_{charge0}) in length. For example, the charging duration (e.g., from time t₁₁ to time t₁₂) does not depend on the voltage 209 (e.g., V_{DD}) at the rising edge of the PWM signal 223 (e.g., at time t₁₁) so long as the voltage 209 at the rising edge of the PWM signal 223 (e.g., at time t₁₁) is smaller than the predetermined charging threshold (e.g., V_{DD_low}).

From time t₁₂ to time t₁₃, the primary current 251 increases gradually as shown by the waveform 751, wherein the primary current 251 is equal to the sensing current 227 in magnitude, according to certain embodiments. In some examples, from time t₁₂ to time t₁₃, the control signal 322 remains at the logic low level as shown by the waveform 722, the control signal 324 remains at the logic low level, and the control signal 326 remains at the logic low level. As an example, from time t₁₂ to time t₁₃, the control signal 235 remains at the logic high level as shown by the waveform 735. In certain examples, from time t₁₂ to time t₁₃, the gate voltage 231 of the transistor 230 remains at the high voltage level that equals the voltage 237 as shown by the waveform 731. For example, from time t₁₂ to time t₁₃, the PMOS transistor 230 remains turned off. As an example, from time t₁₂ to time t₁₃, the voltage 209 decreases gradually as shown by the waveform 709.

At time t₁₃, the PWM signal 223 changes from the logic high level to the logic low level as shown by the waveform 723 according to some embodiments. As an example, at time t₁₃, the control signal 235 changes from the logic high level to the logic low level as shown by the waveform 735, and the power switch 226 (e.g., a transistor) becomes open (e.g., turned off). In certain examples, at time t₁₃, the control signal 322 remains at the logic low level as shown by the waveform 722, the control signal 324 remains at the logic low level, and the control signal 326 remains at the logic low level. For example, at time t₁₃, the PMOS transistor 230 remains turned off. In some examples, at time t₁₃, the primary current 251 drops to zero in magnitude as shown by the waveform 751.

From time t₁₃ to time t₁₄, the PWM signal 223 remains at the logic low level as shown by the waveform 723 according to certain embodiments. As an example, from time t₁₃ to time t₁₄, the control signal 235 remains at the logic low level as shown by the waveform 735, and the power switch 226 (e.g., a transistor) remains open (e.g., turned off). In certain examples, from time t₁₃ to time t₁₄, the control signal 322 remains at the logic low level as shown by the waveform 722, the control signal 324 remains at the logic low level, and the control signal 326 remains at the logic low level. For example, from time t₁₃ to time t₁₄, the PMOS transistor 230 remains turned off. In some examples, from time t₁₃ to time t₁₄, the primary current 251 remains equal to zero in magnitude as shown by the waveform 751. As an example, from time t₁₃ to time t₁₄, the voltage 209 decreases gradually as shown by the waveform 709.

At time t₁₄, the PWM signal 223 changes from the logic low level to the logic high level as shown by the waveform 723 according to some embodiments. In certain examples, at time t₁₄, in response to the voltage 209 being larger than the predetermined charging threshold (e.g., V_{DD_low}) at the rising edge of the PWM signal 223, the control signal 322 remains at the logic low level as shown by the waveform 722. For example, at time t₁₄, the gate voltage 231 of the transistor 230 remains at the high voltage level that equals the voltage 237 as shown by the waveform 731. As an example, at time t₁₄, in response to the gate voltage 231 remains at the high voltage level, the PMOS transistor 230 remains turned off. In some examples, at time t₁₄, the control signal 235 changes from the logic low level to the logic high level as shown by the waveform 735, and the power switch 226 (e.g., a transistor) becomes closed (e.g., turned on). For example, at time t₁₄, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

From time t₁₄ to time t₁₅, the primary current 251 increases gradually as shown by the waveform 751, wherein the primary current 251 is equal to the sensing current 227 in magnitude, according to certain embodiments. In some examples, from time t₁₄ to time t₁₅, the control signal 322 remains at the logic low level as shown by the waveform 722, the control signal 324 remains at the logic low level, and the control signal 326 remains at the logic low level. As an example, from time t₁₄ to time t₁₅, the control signal 235 remains at the logic high level as shown by the waveform 735. In certain examples, from time t₁₄ to time t₁₅, the gate voltage 231 of the transistor 230 remains at the high voltage level that equals the voltage 237 as shown by the waveform 731. For example, from time t₁₄ to time t₁₅, the PMOS transistor 230 remains turned off. As an example, from time t₁₄ to time t₁₅, the voltage 209 decreases gradually as shown by the waveform 709.

At time t₁₅, the PWM signal 223 changes from the logic high level to the logic low level as shown by the waveform 723 according to some embodiments. As an example, at time t₁₅, the control signal 235 changes from the logic high level to the logic low level as shown by the waveform 735, and the power switch 226 (e.g., a transistor) becomes open (e.g., turned off). In certain examples, at time t₁₅, the control signal 322 remains at the logic low level as shown by the waveform 722, the control signal 324 remains at the logic low level, and the control signal 326 remains at the logic low level. For example, at time t₁₅, the PMOS transistor 230 remains turned off. In some examples, at time t₁₅, the primary current 251 drops to zero in magnitude as shown by the waveform 751.

From time t₁₅ to time t₁₆, the PWM signal 223 remains at the logic low level as shown by the waveform 723 according to certain embodiments. As an example, from time t₁₅ to time t₁₆, the control signal 235 remains at the logic low level as shown by the waveform 735, and the power switch 226 (e.g., a transistor) remains open (e.g., turned off). In certain examples, from time t₁₅ to time t₁₆, the control signal 322 remains at the logic low level as shown by the waveform 722, the control signal 324 remains at the logic low level, and the control signal 326 remains at the logic low level. For example, from time t₁₅ to time t₁₆, the PMOS transistor 230 remains turned off. In some examples, from time t₁₅ to time t₁₆, the primary current 251 remains equal to zero in magnitude as shown by the waveform 751. As an example, from time t₁₅ to time t₁₆, the voltage 209 decreases gradually as shown by the waveform 709.

At time t₁₆, the PWM signal 223 changes from the logic low level to the logic high level as shown by the waveform 723 according to some embodiments. In certain examples, at time t₁₆, in response to the voltage 209 being larger than the predetermined charging threshold (e.g., V_{DD_low}) at the rising edge of the PWM signal 223, the control signal 322 remains at the logic low level as shown by the waveform 722. For example, at time t₁₆, the gate voltage 231 of the transistor 230 remains at the high voltage level that equals the voltage 237 as shown by the waveform 731. As an example, at time t₁₆, in response to the gate voltage 231 remains at the high voltage level, the PMOS transistor 230 remains turned off. In some examples, at time t₁₆, the control signal 235 changes from the logic low level to the logic high level as shown by the waveform 735, and the power switch 226 (e.g., a transistor) becomes closed (e.g., turned on). For example, at time t₁₆, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

As shown in FIG. 7, if the voltage 209 at a rising edge of the PWM signal 223 (e.g., at time t₁₁) is smaller than the predetermined charging threshold (e.g., V_{DD_low}), the charging duration starts at the rising edge of the PWM signal 223 (e.g., at time t₁₁), and the length of the charging duration (e.g., from time t₁₁ to time t₁₂) is equal to a predetermined constant (e.g., T_{charge0}) according to certain embodiments. Also as shown in FIG. 7, if the voltage 209 at a rising edge of the PWM signal 223 (e.g., at time t₁₄ and/or at the time t₁₆) is not smaller than the predetermined charging threshold (e.g., V_{DD_low}), the charging duration does not start according to some embodiments.

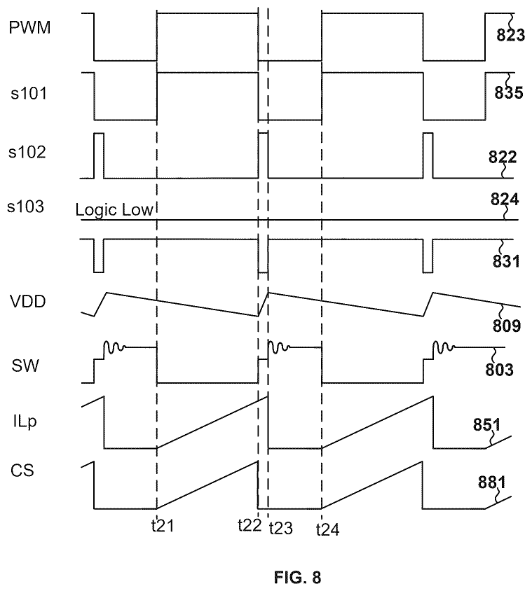

FIG. 8 shows simplified timing diagrams for the power supply system 200 if the load 292 is a non-light load as shown in FIG. 2, FIG. 3 and/or FIG. 4 according to some embodiments of the present disclosure. These diagrams are merely examples, which should not unduly limit the scope of the claims. One of ordinary skill in the art would recognize many variations, alternatives, and modifications. The waveform 823 represents the PWM signal 223 as a function of time, the waveform 809 represents the voltage 209 as a function of time, the waveform 835 represents the control signal 235 as a function of time, the waveform 822 represents the control signal 322 as a function of time, the waveform 824 represents the control signal 324 as a function of time, the waveform 831 represents the control signal 231 as a function of time, the waveform 803 represents the voltage 203 as a function of time, the waveform 851 represents the primary current 251 as a function of time, and the waveform 881 represents the sensing voltage 281 as a function of time.

As shown in FIG. 2 and FIG. 3, the transistor 230 is a PMOS transistor according to certain embodiments. In some examples, at a falling edge of the PWM signal 223, the PMOS transistor 230 becomes turned on to operate in the linear region and then remains in the linear region for a charging duration, wherein the length of the charging duration depends at least in part on the voltage 209 at a falling edge of the PWM signal 223. For example, the length of the charging duration increases if the voltage 209 at a falling edge of the PWM signal 223 decreases. As an example, the length of the charging duration decreases if the voltage 209 at a falling edge of the PWM signal 223 increases. In certain examples, the control signals 324 and 326 both remain at the logic low level.

At time t₂₁, the PWM signal 223 changes from a logic low level to a logic high level as shown by the waveform 823 according to some embodiments. In certain examples, at time t₂₁, the control signal 322 is at a logic low level as shown by the waveform 822. For example, at time t₂₁, the gate voltage 231 of the transistor 230 is at a high voltage level that equals the voltage 237 as shown by the waveform 831. As an example, at time t₂₁, the PMOS transistor 230 is turned off. In some examples, at time t₂₁, the control signal 235 changes from a logic low level to a logic high level as shown by the waveform 835, and the power switch 226 (e.g., a transistor) becomes closed (e.g., turned on). For example, at time t₂₁, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

From time t₂₁ to time t₂₂, the GaN switch 240 remains turned on, the PMOS transistor 230 remains turned off, and the power switch 226 (e.g., a transistor) remains closed (e.g., turned on) according to certain embodiments. In some examples, from time t₂₁ to time t₂₂, the control signal 322 remains at the logic low level as shown by the waveform 822, the control signal 324 remains at the logic low level as shown by the waveform 824, and the control signal 326 remains at the logic low level. As an example, from time t₂₁ to time t₂₂, the control signal 235 remains at the logic high level as shown by the waveform 835. In certain examples, from time t₂₁ to time t₂₂, the supply capacitor 274 is not being charged. For example, from time t₂₁ to time t₂₂, the voltage 209 decreases gradually as shown by the waveform 809. As an example, from time t₂₁ to time t₂₂, the primary current 251 increases gradually from zero as shown by the waveform 851, wherein the primary current 251 is equal to the sensing current 227.

At time t₂₂, the PWM signal 223 changes from the logic high level to the logic low level as shown by the waveform 823 according to some embodiments. As an example, at time t₂₂, the control signal 235 changes from the logic high level to the logic low level as shown by the waveform 835, and the power switch 226 (e.g., a transistor) becomes open (e.g., turned off). In certain examples, at time t₂₂, in response to the falling edge of the PWM signal 223, the control signal 322 changes from the logic low level to a logic high level as shown by the waveform 822. For example, at time t₂₂, the gate voltage 231 of the transistor 230 drops from the high voltage level that equals the voltage 237 to a low voltage level that equals the voltage 237 minus the breakdown voltage (e.g., V₀) of the Zener diode 460 as shown by the waveform 831. As an example, at time t₂₂, in response to the gate voltage 231 dropping from the high voltage level to the low voltage level, the PMOS transistor 230 becomes turned on to operate in the linear region, causing the GaN switch 240 to remain turned on. In some examples, at time t₂₂, the primary current 251 starts flowing through the primary winding 250, the GaN switch 240, the diode 232 and the transistor 230 to serve as the charging current 279, wherein the charging current 279 is equal to the primary current 251 in magnitude. For example, at time t₂₂, the charging of the supply capacitor 274 starts.

From time t₂₂ to time t₂₃, the GaN switch 240 remains turned on, and the PMOS transistor 230 remains in the linear region according to certain embodiments. In some examples, from time t₂₂ to time t₂₃, the control signal 322 remains at the logic high level as shown by the waveform 822, the control signal 324 remains at the logic low level as shown by the waveform 824, and the control signal 326 remains at the logic low level. As an example, from time t₂₂ to time t₂₃, the control signal 235 remains at the logic low level as shown by the waveform 835. In certain examples, from time t₂₂ to time t₂₃, the supply capacitor 274 is charged by the charging current 279. For example, from time t₂₂ to time t₂₃, the voltage 209 rises gradually as shown by the waveform 809. As an example, from time t₂₂ to time t₂₃, the primary current 251 increases gradually as shown by the waveform 851, wherein the primary current 251 is equal to the charging current 279.

At time t₂₃, the control signal 322 changes from the logic high level to the logic low level as shown by the waveform 822 according to some embodiments. For example, at time t₂₃, the gate voltage 231 of the transistor 230 rises from the low voltage level that equals the voltage 237 minus the breakdown voltage (e.g., V₀) of the Zener diode 460 to the high voltage level that equals the voltage 237 as shown by the waveform 831. In certain examples, at time t₂₃, in response to the gate voltage 231 rising from the low voltage level to the high voltage level, the PMOS transistor 230 becomes turned off and the charging of the supply capacitor 274 stops. For example, the time duration from time t₂₂ to time t₂₃ is a charging duration, during which the supply capacitor 274 is charged by the charging current 279. In some examples, at time t₂₃, the control signal 235 remains at the logic low level as shown by the waveform 835, and the power switch 226 (e.g., a transistor) becomes closed (e.g., turned on). For example, at time t₂₃, the primary current 251 drops to zero in magnitude as shown by the waveform 851.

From time t₂₃ to time t₂₄, the PWM signal 223 remains at the logic low level as shown by the waveform 823 according to certain embodiments. As an example, from time t₂₃ to time t₂₄, the control signal 235 remains at the logic low level as shown by the waveform 835, and the power switch 226 (e.g., a transistor) remains open (e.g., turned off). In certain examples, from time t₂₃ to time t₂₄, the control signal 322 remains at the logic low level as shown by the waveform 822, the control signal 324 remains at the logic low level as shown by the waveform 824, and the control signal 826 remains at the logic low level. For example, from time t₂₃ to time t₂₄, the PMOS transistor 230 remains turned off. In some examples, from time t₂₃ to time t₂₄, the primary current 251 remains equal to zero in magnitude as shown by the waveform 851. As an example, from time t₂₃ to time t₂₄, the voltage 209 decreases gradually as shown by the waveform 809.

At time t₂₄, the PWM signal 223 changes from the logic low level to the logic high level as shown by the waveform 823 according to some embodiments. In certain examples, at time t₂₄, the control signal 322 remains at the logic low level as shown by the waveform 822. For example, at time t₂₄, the gate voltage 231 of the transistor 230 remains at the high voltage level that equals the voltage 237 as shown by the waveform 831. As an example, at time t₂₄, the PMOS transistor 230 remains turned off. In some examples, at time t₂₄, the control signal 235 changes from the logic low level to the logic high level as shown by the waveform 835, and the power switch 226 (e.g., a transistor) becomes closed (e.g., turned on). For example, at time t₂₄, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

As shown in FIG. 8, the charging duration starts at the falling edge of the PWM signal 223 (e.g., at time t₂₂) without making a comparison between the voltage 209 and a predetermined charging threshold, and the length of the charging duration (e.g., from time t₂₂ to time t₂₃) depends at least in part on the voltage 209 at the start of the charging duration (e.g., at time t₂₂). In certain examples, if the voltage 209 at the start of the charging duration (e.g., at time t₂₂) exceeds a predetermined maximum value, the length of the charging duration (e.g., from time t₂₂ to time t₂₃) equals zero, and if the voltage 209 at the start of the charging duration (e.g., at time t₂₂) does not exceed the predetermined maximum value, the length of the charging duration (e.g., from time t₂₂ to time t₂₃) increases if the voltage 209 at the start of the charging duration (e.g., at time t₂₂) decreases, wherein the predetermined maximum value is larger than the predetermined charging threshold. As an example, the length of the charging duration (e.g., from time t₂₂ to time t₂₃) decreases if the voltage 209 at the start of the charging duration (e.g., at time t₂₂) increases. In some examples, if the voltage 209 at the start of the charging duration (e.g., at time t₂₂) exceeds the predetermined maximum value, the length of the charging duration (e.g., from time t₂₂ to time t₂₃) equals zero by setting time t₂₃ to be the same as time t₂₂. For example, at time t₂₂ that is equal to time t₂₃, the control signal 322 remains at the logic low level, the gate voltage 231 of the transistor 230 remains at the high voltage level that equals the voltage 237, the PMOS transistor 230 remains turned off, and the supply capacitor 274 is not being charged.

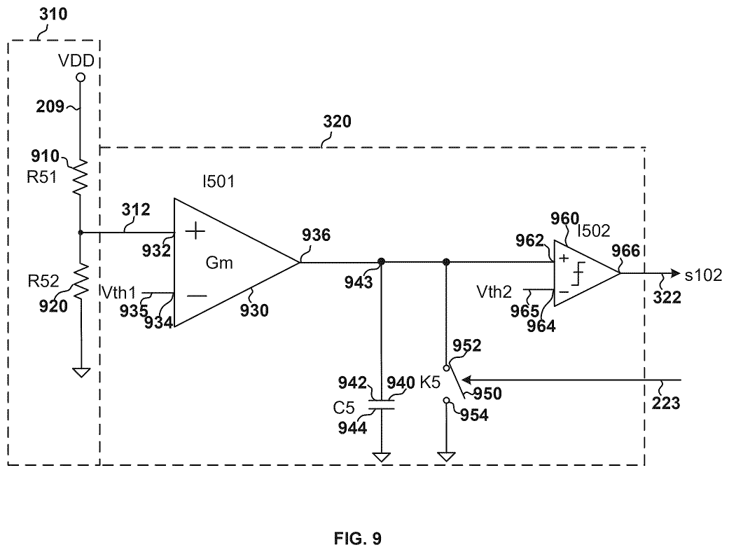

FIG. 9 is a simplified diagram showing certain components of the voltage detection module 310 and the signal control module 320 as parts of the control chip 220 of the power supply system 200 as shown in FIG. 2, FIG. 3 and FIG. 8 according to some embodiments of the present disclosure. This diagram is merely an example, which should not unduly limit the scope of the claims. One of ordinary skill in the art would recognize many variations, alternatives, and modifications. The voltage detection module 310 includes resistors 910 and 920, and the signal control module 320 includes a transconductance amplifier 930, a capacitor 940, a switch 950, and a comparator 960. Although the above has been shown using a selected group of components for the voltage detection module and the signal control module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to certain embodiments, the components of the voltage detection module 310 and the signal control module 320 as shown in FIG. 9 are used to implement the control mechanism as shown in FIG. 8. In some examples, as shown in FIG. 8, if the voltage 209 at the start of the charging duration (e.g., at time t₂₂) decreases, the length of the charging duration (e.g., from time t₂₂ to time t₂₃) increases, and if the voltage 209 at the start of the charging duration (e.g., at time t₂₂) increases, the length of the charging duration (e.g., from time t₂₂ to time t₂₃) decreases. In certain examples, the resistors 910 and 920 are connected in series to form a voltage divider, which is biased between the voltage 209 of the terminal 208 (e.g., V_{DD}) and the system ground to generate the detection signal 312, wherein the detection signal 312 represents the magnitude of the voltage 209.

According to some embodiments, the transconductance amplifier 930 includes an input terminal 932 (e.g., a non-inverting input terminal), an input terminal 934 (e.g., an inverting input terminal), and an output terminal 936. For example, the input terminal 932 (e.g., a non-inverting input terminal) receives the detection signal 312. As an example, the input terminal 934 (e.g., an inverting input terminal) receives a threshold voltage 935 (e.g., Vₜₕ₁). In certain examples, the capacitor 940 includes terminals 942 and 944, and the switch 950 includes terminals 952 and 954. In some examples, the comparator 960 includes an input terminal 962 (e.g., a non-inverting input terminal), an input terminal 964 (e.g., an inverting input terminal), and an output terminal 966. For example, the output terminal 936 of the transconductance amplifier 930 is connected to the terminal 942 of the capacitor 940, the terminal 952 of the switch 950, and the input terminal 962 (e.g., a non-inverting input terminal) of the comparator 960. As an example, the terminal 944 of the capacitor 940 and the terminal 954 of the switch 950 both are biased to the system ground. In certain examples, the PWM signal 223 is used to open and/or close the switch 950. For example, if the PWM signal 223 is at the logic low level, the switch 950 is open. As an example, if the PWM signal 223 is at the logic high level, the switch 950 is closed.

In some embodiments, the input terminal 962 (e.g., a non-inverting input terminal) of the comparator 960 is biased to a voltage 943 at the terminal 942 of the capacitor 940, and the input terminal 964 (e.g., an inverting input terminal) of the comparator 960 receives a threshold voltage 965 (e.g., Vₜₕ₂). In certain examples, the comparator 660 compares the voltage 943 and the threshold voltage 965 (e.g., Vₜₕ₂) and generates the control signal 322. For example, the control signal 322 changes from the logic low level to the logic high level, remains at the logic high level, and then changes from the logic high level back to the logic low level to form a pulse (e.g., as shown by the waveform 822 of FIG. 8). As an example, the pulse width of the control signal 322 is equal to the charging duration (e.g., the time duration from time t₂₂ to time t₂₃ as shown in FIG. 8).

According to certain embodiments, the pulse width of the control signal 322 (e.g., the charging duration) is determined as follows:

$${T}_{c h a r g e} = \frac{{C}_{5} \times {V}_{t h 2}}{{g}_{m} \times ( \frac{{V}_{D D} \times {R}_{b}}{{R}_{a} + {R}_{b}} - {V}_{t h 1} )} \qquad ( Equation 2 )$$

where T_{charge} represents the pulse width of the control signal 322 (e.g., the charging duration). Additionally, Rₐ represents the resistance of the resistor 910, and R_{b} represents the resistance of the resistor 920. Moreover, Vₜₕ₁ represents the threshold voltage 935, and Vₜₕ₂ represents the threshold voltage 965. Also, V_{DD} represents the voltage 209 at the terminal 208 (e.g., the supply voltage for the control chip 220). Additionally, C₅ represents the capacitance of the capacitor 940, and gₘ represents the transconductance coefficient of the transconductance amplifier 930.

According to some embodiments, as shown in FIG. 8, if the voltage 209 (e.g., V_{DD}) at the start of the charging duration (e.g., at time t₂₂) decreases, the charging duration (e.g., from time t₂₂ to time t₂₃) increases, and if the voltage 209 (e.g., V_{DD}) at the start of the charging duration (e.g., at time t₂₂) increases, the charging duration (e.g., from time t₂₂ to time t₂₃) decreases. For example, the charging duration (e.g., from time t₂₂ to time t₂₃) depends at least in part on the voltage 209 (e.g., V_{DD}) at a falling edge of the PWM signal 223 (e.g., at time t₂₂ as shown by the waveform 823).

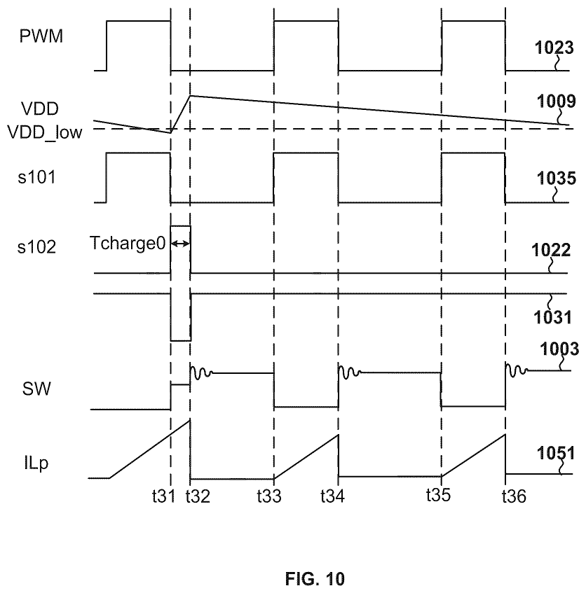

FIG. 10 shows simplified timing diagrams for the power supply system 200 if the load 292 is a non-light load as shown in FIG. 2, FIG. 3 and/or FIG. 4 according to some embodiments of the present disclosure. These diagrams are merely examples, which should not unduly limit the scope of the claims. One of ordinary skill in the art would recognize many variations, alternatives, and modifications. The waveform 1023 represents the PWM signal 223 as a function of time, the waveform 1009 represents the voltage 209 as a function of time, the waveform 1035 represents the control signal 235 as a function of time, the waveform 1022 represents the control signal 322 as a function of time, the waveform 1031 represents the control signal 231 as a function of time, the waveform 1003 represents the voltage 203 as a function of time, and the waveform 1051 represents the primary current 251 as a function of time.

As shown in FIG. 2 and FIG. 3, the transistor 230 is a PMOS transistor according to certain embodiments. In some examples, at a falling edge of the PWM signal 223, if the voltage 209 is smaller than a predetermined charging threshold (e.g., V_{DD_low}), the PMOS transistor 230 becomes turned on to operate in the linear region and then remains in the linear region for a predetermined charging duration, wherein the length of the predetermined charging duration is equal to a predetermined constant (e.g., T_{charge0}). In certain examples, at a falling edge of the PWM signal 223, if the voltage 209 is not smaller than the predetermined charging threshold (e.g., V_{DD_low}), the PMOS transistor 230 remains turned off. For example, if the voltage 209 is not smaller than the predetermined charging threshold (e.g., V_{DD_low}), there is no need to charge the supply capacitor 274. In some examples, the control signals 324 and 326 both remain at the logic low level.

At time t₃₁, the PWM signal 223 changes from a logic high level to a logic low level as shown by the waveform 1023 according to some embodiments. In certain examples, at time t₃₁, in response to the voltage 209 being smaller than the predetermined charging threshold (e.g., V_{DD_low}) at the falling edge of the PWM signal 223, the control signal 322 changes from a logic low level to a logic high level as shown by the waveform 1022. For example, at time t₃₁, the gate voltage 231 of the transistor 230 drops from a high voltage level that equals the voltage 237 to a low voltage level that equals the voltage 237 minus the breakdown voltage (e.g., V₀) of the Zener diode 460 as shown by the waveform 1031. As an example, at time t₃₁, in response to the gate voltage 231 dropping from the high voltage level to the low voltage level, the PMOS transistor 230 becomes turned on to operate in the linear region, causing the GaN switch 240 to turn on. In some examples, at time t₃₁, the primary current 251 starts flowing through the primary winding 250, the GaN switch 240, the diode 232 and the transistor 230 to serve as the charging current 279, wherein the charging current 279 is equal to the primary current 251 in magnitude. For example, at time t₃₁, the charging of the supply capacitor 274 starts. In some examples, at the falling edge of the PWM signal 223 (e.g., at time t₃₁), the driver control module 234 (e.g., the signal control module 320) compares the voltage 209 with the predetermined charging threshold (e.g., V_{DD_low}). For example, if the voltage 209 at the falling edge of the PWM signal 223 (e.g., at time t₃₁) is smaller than the predetermined charging threshold (e.g., V_{DD_low}), the driver control module 234 (e.g., the signal control module 320) changes the control signal 322 from the logic low level to the logic high level as shown by the waveform 1022 so that the gate voltage 231 of the transistor 230 drops from the high voltage level that equals the voltage 237 to the low voltage level that equals the voltage 237 minus the breakdown voltage (e.g., V₀) of the Zener diode 460 as shown by the waveform 1031.

From time t₃₁ to time t₃₂, the GaN switch 240 remains turned on, and the PMOS transistor 230 remains in the linear region according to certain embodiments. In some examples, from time t₃₁ to time t₃₂, the control signal 322 remains at the logic high level as shown by the waveform 1022, the control signal 324 remains at the logic low level, and the control signal 326 remains at the logic low level. As an example, from time t₃₁ to time t₃₂, the control signal 235 remains at the logic low level as shown by the waveform 1035. In certain examples, from time t₃₁ to time t₃₂, the supply capacitor 274 is charged by the charging current 279. For example, from time t₃₁ to time t₃₂, the voltage 209 rises gradually as shown by the waveform 1009. As an example, from time t₃₁ to time t₃₂, the primary current 251 increases gradually as shown by the waveform 1051, wherein the primary current 251 is equal to the charging current 279.

At time t₃₂, the control signal 322 changes from the logic high level to the logic low level as shown by the waveform 1022 according to some embodiments. For example, at time t₃₂, the gate voltage 231 of the transistor 230 rises from the low voltage level that equals the voltage 237 minus the breakdown voltage (e.g., V₀) of the Zener diode 460 to the high voltage level that equals the voltage 237 as shown by the waveform 1031. In certain examples, at time t₃₂, in response to the gate voltage 231 rising from the low voltage level to the high voltage level, the PMOS transistor 230 becomes turned off and the charging of the supply capacitor 274 stops. For example, the time duration from time t₃₁ to time t₃₂ is a charging duration, during which the supply capacitor 274 is charged by the charging current 279. In some examples, at time t₃₂, the control signal 235 changes from a logic high level to a logic low level as shown by the waveform 1035, and the power switch 226 (e.g., a transistor) becomes open (e.g., turned off). For example, at time t₃₂, the primary current 251 drops to zero in magnitude as shown by the waveform 1051. In certain examples, the charging duration (e.g., from time t₃₁ to time t₃₂) is equal to the predetermined constant (e.g., T_{charge0}) in length. For example, the charging duration (e.g., from time t₃₁ to time t₃₂) does not depend on the voltage 209 (e.g., V_{DD}) at the falling edge of the PWM signal 223 (e.g., at time t₃₁) so long as the voltage 209 at the falling edge of the PWM signal 223 (e.g., at time t₃₁) is smaller than the predetermined charging threshold (e.g., V_{DD_low}).

From time t₃₂ to time t₃₃, the primary current 251 remains equal to zero in magnitude as shown by the waveform 1051 according to certain embodiments. In some examples, from time t₃₂ to time t₃₃, the control signal 322 remains at the logic low level as shown by the waveform 1022, the control signal 324 remains at the logic low level, and the control signal 326 remains at the logic low level. As an example, from time t₃₂ to time t₃₃, the control signal 235 remains at the logic low level as shown by the waveform 1035. In certain examples, from time t₃₂ to time t₃₃, the gate voltage 231 of the transistor 230 remains at the high voltage level that equals the voltage 237 as shown by the waveform 1031. For example, from time t₃₂ to time t₃₃, the PMOS transistor 230 remains turned off. As an example, from time t₃₂ to time t₃₃, the voltage 209 decreases gradually as shown by the waveform 1009.

At time t₃₃, the PWM signal 223 changes from the logic low level to the logic high level as shown by the waveform 1023 according to some embodiments. As an example, at time t₃₃, the control signal 235 changes from the logic low level to the logic high level as shown by the waveform 1035, and the power switch 226 (e.g., a transistor) becomes closed (e.g., turned on). In certain examples, at time t₃₃, the control signal 322 remains at the logic low level as shown by the waveform 1022, the control signal 324 remains at the logic low level, and the control signal 326 remains at the logic low level. For example, at time t₃₃, the PMOS transistor 230 remains turned off. For example, at time t₃₃, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

From time t₃₃ to time t₃₄, the PWM signal 223 remains at the logic high level as shown by the waveform 1023 according to certain embodiments. As an example, from time t₃₃ to time t₃₄, the control signal 235 remains at the logic high level as shown by the waveform 1035, and the power switch 226 (e.g., a transistor) remains closed (e.g., turned on). In certain examples, from time t₃₃ to time t₃₄, the control signal 322 remains at the logic low level as shown by the waveform 1022, the control signal 324 remains at the logic low level, and the control signal 326 remains at the logic low level. For example, from time t₃₃ to time t₃₄, the PMOS transistor 230 remains turned off. In some examples, from time t₃₃ to time t₃₄, the supply capacitor 274 is not being charged. For example, from time t₃₃ to time t₃₄, the voltage 209 decreases gradually as shown by the waveform 1009. As an example, from time t₃₃ to time t₃₄, the primary current 251 increases gradually from zero as shown by the waveform 1051, wherein the primary current 251 is equal to the sensing current 227.

At time t₃₄, the PWM signal 223 changes from the logic high level to the logic low level as shown by the waveform 1023 according to some embodiments. In certain examples, at time t₃₄, in response to the voltage 209 being larger than the predetermined charging threshold (e.g., V_{DD_low}) at the falling edge of the PWM signal 223, the control signal 322 remains at the logic low level as shown by the waveform 1022. For example, at time t₃₄, the gate voltage 231 of the transistor 230 remains at the high voltage level that equals the voltage 237 as shown by the waveform 1031. As an example, at time t₃₄, in response to the gate voltage 231 remains at the high voltage level, the PMOS transistor 230 remains turned off. In some examples, at time t₃₄, the control signal 235 changes from the logic high level to the logic low level as shown by the waveform 1035, and the power switch 226 (e.g., a transistor) becomes open (e.g., turned off). For example, at time t₃₄, the primary current 251 drops to zero in magnitude as shown by the waveform 1051.

From time t₃₄ to time t₃₅, the primary current 251 remains equal to zero in magnitude as shown by the waveform 1051 according to certain embodiments. In some examples, from time t₃₄ to time t₃₅, the control signal 322 remains at the logic low level as shown by the waveform 1022, the control signal 324 remains at the logic low level, and the control signal 326 remains at the logic low level. As an example, from time t₃₄ to time t₃₅, the control signal 235 remains at the logic low level as shown by the waveform 1035. In certain examples, from time t₃₄ to time t₃₅, the gate voltage 231 of the transistor 230 remains at the high voltage level that equals the voltage 237 as shown by the waveform 1031. For example, from time t₃₄ to time t₃₅, the PMOS transistor 230 remains turned off. As an example, from time t₃₄ to time t₃₅, the voltage 209 decreases gradually as shown by the waveform 1009.

At time t₃₅, the PWM signal 223 changes from the logic low level to the logic high level as shown by the waveform 1023 according to some embodiments. As an example, at time t₃₅, the control signal 235 changes from the logic low level to the logic high level as shown by the waveform 1035, and the power switch 226 (e.g., a transistor) becomes closed (e.g., turned on). In certain examples, at time t₃₅, the control signal 322 remains at the logic low level as shown by the waveform 1022, the control signal 324 remains at the logic low level, and the control signal 326 remains at the logic low level. For example, at time t₃₅, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

From time t₃₅ to time t₃₆, the PWM signal 223 remains at the logic high level as shown by the waveform 1023 according to certain embodiments. As an example, from time t₃₅ to time t₃₆, the control signal 235 remains at the logic high level as shown by the waveform 1035, and the power switch 226 (e.g., a transistor) remains closed (e.g., turned on). In certain examples, from time t₃₅ to time t₃₆, the control signal 322 remains at the logic low level as shown by the waveform 1022, the control signal 324 remains at the logic low level, and the control signal 326 remains at the logic low level. For example, from time t₃₅ to time t₃₆, the PMOS transistor 230 remains turned on. In some examples, from time t₃₅ to time t₃₆, the primary current 251 increases gradually from zero as shown by the waveform 1051, wherein the primary current 251 is equal to the sensing current 227.

At time t₃₆, the PWM signal 223 changes from the logic high level to the logic low level as shown by the waveform 1023 according to some embodiments. In certain examples, at time t₃₆, in response to the voltage 209 being larger than the predetermined charging threshold (e.g., V_{DD_low}) at the falling edge of the PWM signal 223, the control signal 322 remains at the logic low level as shown by the waveform 1022. For example, at time t₃₆, the gate voltage 231 of the transistor 230 remains at the high voltage level that equals the voltage 237 as shown by the waveform 1031. As an example, at time t₃₆, in response to the gate voltage 231 remains at the high voltage level, the PMOS transistor 230 remains turned off. In some examples, at time t₃₆, the control signal 235 changes from the logic high level to the logic low level as shown by the waveform 1035, and the power switch 226 (e.g., a transistor) becomes open (e.g., turned off). For example, at time t₃₆, the primary current 251 drops to zero in magnitude as shown by the waveform 1051.

As shown in FIG. 10, if the voltage 209 at a falling edge of the PWM signal 223 (e.g., at time t₃₁) is smaller than the predetermined charging threshold (e.g., V_{DD_low}), the charging duration starts at the falling edge of the PWM signal 223 (e.g., at time t₃₁), and the length of the charging duration (e.g., from time t₃₁ to time t₃₂) is equal to a predetermined constant (e.g., T_{charge0}) according to certain embodiments. Also as shown in FIG. 10, if the voltage 209 at a falling edge of the PWM signal 223 (e.g., at time t₃₄ and/or at the time t₃₆) is not smaller than the predetermined charging threshold (e.g., V_{DD_low}), the charging duration does not start according to some embodiments.

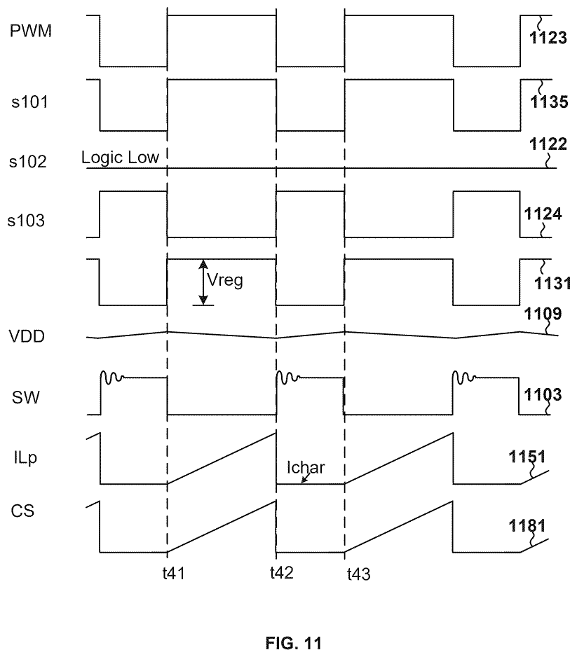

FIG. 11 shows simplified timing diagrams for the power supply system 200 if the load 292 is a light load as shown in FIG. 2, FIG. 3 and/or FIG. 4 according to some embodiments of the present disclosure. These diagrams are merely examples, which should not unduly limit the scope of the claims. One of ordinary skill in the art would recognize many variations, alternatives, and modifications. The waveform 1123 represents the PWM signal 223 as a function of time, the waveform 1109 represents the voltage 209 as a function of time, the waveform 1135 represents the control signal 235 as a function of time, the waveform 1122 represents the control signal 322 as a function of time, the waveform 1124 represents the control signal 324 as a function of time, the waveform 1131 represents the control signal 231 as a function of time, the waveform 1103 represents the voltage 203 as a function of time, the waveform 1151 represents the primary current 251 as a function of time, and the waveform 1181 represents the sensing voltage 281 as a function of time. In some examples, the load 292 is a light load, the transistor 230 is a PMOS transistor, and the control signals 322 and 326 both remain at a logic low level.

At time t₄₁, the PWM signal 223 changes from a logic low level to a logic high level as shown by the waveform 1123 according to some embodiments. In certain examples, at time t₄₁, the control signal 322 is at a logic low level as shown by the waveform 1122, the control signal 324 changes from a logic high level to a logic low level as shown by the waveform 1124, and the control signal 326 is at a logic low level. For example, at time t₄₁, the gate voltage 231 of the transistor 230 changes from a low voltage level that equals the voltage 237 minus a regulation voltage (e.g., V_{reg}) to a high voltage level that equals the voltage 237 as shown by the waveform 1131. As an example, the magnitude of the regulation voltage (e.g., the absolute value of V_{reg}) is smaller than the magnitude of the breakdown voltage (e.g., the absolute value of V₀) of the Zener diode 460. For example, at time t₄₁, in response to the gate voltage 231 of the transistor 230 changing from the low voltage level to the high voltage level, the PMOS transistor 230 becomes turned off. In some examples, at time t₄₁, the control signal 235 changes from a logic low level to a logic high level as shown by the waveform 1135, and the power switch 226 (e.g., a transistor) becomes closed (e.g., turned on). As an example, at time t₄₁, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

From time t₄₁ to time t₄₂, the PWM signal 223 remains at the logic high level as shown by the waveform 1123 according to some embodiments. In certain examples, from time t₄₁ to time t₄₂, the control signal 322 remains at the logic low level as shown by the waveform 1122, the control signal 324 remains at the logic low level as shown by the waveform 1124, and the control signal 326 remains at the logic low level. For example, from time t₄₁ to time t₄₂, the gate voltage 231 of the transistor 230 remains at the high voltage level that equals the voltage 237 as shown by the waveform 1131. As an example, from time t₄₁ to time t₄₂, the PMOS transistor 230 remains turned off. In some examples, from time t₄₁ to time t₄₂, the control signal 235 remains at the logic high level as shown by the waveform 1135, and the power switch 226 (e.g., a transistor) remains closed (e.g., turned on). As an example, from time t₄₁ to time t₄₂, the primary current 251 increases gradually from zero as shown by the waveform 1151, wherein the primary current 251 is equal to the sensing current 227. For example, from time t₄₁ to time t₄₂, the voltage 209 decreases gradually as shown by the waveform 509.

At time t₄₂, the PWM signal 223 changes from the logic high level to the logic low level as shown by the waveform 1123 according to some embodiments. In certain examples, at time t₄₂, the control signal 322 remains at the logic low level as shown by the waveform 1122, the control signal 324 changes from the logic low level to the logic high level as shown by the waveform 1124, and the control signal 326 remains at the logic low level. For example, at time t₄₂, the gate voltage 231 of the transistor 230 changes from the high voltage level that equals the voltage 237 to the low voltage level that equals the voltage 237 minus the regulation voltage (e.g., V_{reg}) as shown by the waveform 1131. As an example, at time t₄₂, in response to the gate voltage 231 of the transistor 230 changing from the high voltage level to the low voltage level, the PMOS transistor 230 becomes turned on to operate in the saturation region. In some examples, at time t₄₂, the control signal 235 changes from the logic high level to the logic low level as shown by the waveform 1135, and the power switch 226 (e.g., a transistor) becomes open (e.g., turned off). As an example, at time t₄₂, the primary current 251 starts flowing through the primary winding 250, the GaN switch 240, the diode 232 and the transistor 230 to serve as the charging current 279, wherein the charging current 279 is equal to the primary current 251 in magnitude. For example, at time t₄₂, the charging of the supply capacitor 274 starts.

From time t₄₂ to time t₄₃, the PWM signal 223 remains at the logic low level as shown by the waveform 1123 according to some embodiments. In certain examples, from time t₄₂ to time t₄₃, the control signal 322 remains at the logic low level as shown by the waveform 1122, the control signal 324 remains at the logic high level as shown by the waveform 1124, and the control signal 326 remains at the logic low level. For example, from time t₄₂ to time t₄₃, the gate voltage 231 of the transistor 230 remains at the low voltage level that equals the voltage 237 minus the regulation voltage (e.g., V_{reg}) as shown by the waveform 1131. As an example, from time t₄₂ to time t₄₃, in response to the gate voltage 231 of the transistor 230 remaining at the low voltage level, the PMOS transistor 230 remains turned on, operating in the saturation region. In some examples, from time t₄₂ to time t₄₃, the control signal 235 remains at the logic low level as shown by the waveform 1135, and the power switch 226 (e.g., a transistor) remains open (e.g., turned off). In certain examples, from time t₄₂ to time t₄₃, the supply capacitor 274 is charged by the charging current 279. For example, from time t₄₂ to time t₄₃, the voltage 209 rises gradually as shown by the waveform 1109. As an example, from time t₄₂ to time t₄₃, the primary current 251 is equal to the charging current 279. For example, from time t₄₂ to time t₄₃, the charging current 279 is equal to a constant (e.g., I_{char}) in magnitude. In some examples, the charging current 279 achieves high efficiency for the power supply system 200 (e.g., a switching power supply system) when the load 292 is a light load.

At time t₄₃, the PWM signal 223 changes from the logic low level to the logic high level as shown by the waveform 1123 according to some embodiments. In certain examples, at time t₄₃, the control signal 322 remains at the logic low level as shown by the waveform 1122, the control signal 324 changes from the logic high level to the logic low level as shown by the waveform 1124, and the control signal 326 remains at the logic low level. For example, at time t₄₃, the gate voltage 231 of the transistor 230 changes from the low voltage level that equals the voltage 237 minus the regulation voltage (e.g., V_{reg}) to the high voltage level that equals the voltage 237 as shown by the waveform 1131. As an example, at time t₄₃, in response to the gate voltage 231 of the transistor 230 changing from the low voltage level to the high voltage level, the PMOS transistor 230 becomes turned off. In some examples, at time t₄₃, the control signal 235 changes from the logic low level to the logic high level as shown by the waveform 1135, and the power switch 226 (e.g., a transistor) becomes closed (e.g., turned on). As an example, at time t₄₃, the primary current 251 starts flowing through the primary winding 250, the GaN switch 240 and the power switch 226 to serve as the sensing current 227, wherein the sensing current 227 flows through the current sensing resistor 280 to the system ground, and the sensing current 227 is equal to the primary current 251 in magnitude.

As shown in FIG. 2, the terminal 282 of the current sensing resistor 280 is connected to the terminal 204 (e.g., CS) of the control chip 220, and the terminal 284 of the current sensing resistor 280 is biased to the system ground according to certain embodiments. For example, as shown in FIG. 2, the terminal 275 of the supply capacitor 274 is connected to the terminal 208 (e.g., VDD) of the control chip 220, and the terminal 277 of the supply capacitor 274 is biased to the system ground. As an example, as shown in FIG. 2, the terminal 206 (e.g., GND) of the control chip 220 is biased to the system ground. As mentioned above and further emphasized here, FIG. 2 is merely an example, which should not unduly limit the scope of the claims. One of ordinary skill in the art would recognize many variations, alternatives, and modifications.

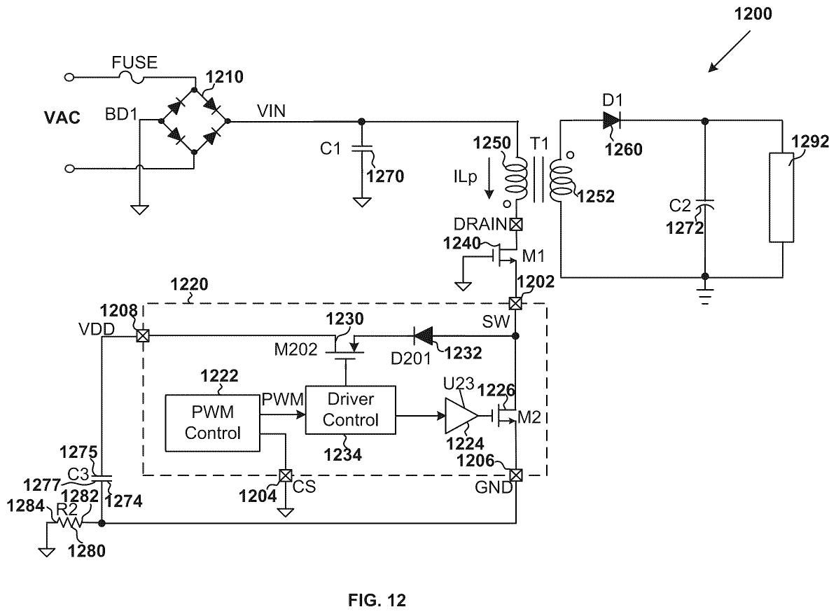

FIG. 12 is a simplified diagram showing a power supply system with a GaN switch according to some embodiments of the present disclosure. This diagram is merely an example, which should not unduly limit the scope of the claims. One of ordinary skill in the art would recognize many variations, alternatives, and modifications. The power supply system 1200 (e.g., a switching power supply system) includes a full-wave rectifier 1210, a control chip 1220, a GaN switch 1240 (e.g., a GaN power switch), a transformer that includes a primary winding 1250 and a secondary winding 1252, a diode 1260, an input capacitor 1270, an output capacitor 1272, a supply capacitor 1274, and a current sensing resistor 1280. The control chip 1220 includes a terminal 1202 (e.g., SW), a terminal 1204 (e.g., CS), a terminal 1206 (e.g., GND), and a terminal 1208 (e.g., VDD). Additionally, the control chip 1220 includes a pulse-width-modulation (PWM) control module 1222, a gate driver 1224, a switch 1226 (e.g., a power switch), a transistor 1230 (e.g., a supply transistor), a diode 1232, and a driver control module 1234. As an example, the power supply system 1200 (e.g., a switching power supply system) is used to provide power to a load 1292, wherein the load 1292 is configured to receive the power from the power supply system 1200 (e.g., a switching power supply system). For example, the power supply system 1200 (e.g., a switching power supply system) implements a flyback architecture. As an example, the GaN switch 1240 (e.g., a GaN power switch) is a GaN transistor. For example, the power switch 1226 (e.g., a transistor) is an NMOS transistor. Although the above has been shown using a selected group of components for the power supply system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

For example, the full-wave rectifier 1210 is the same as the full-wave rectifier 210. As an example, the GaN switch 1240 (e.g., a GaN power switch) is the same as the GaN switch 240 (e.g., a GaN power switch). For example, the transformer that includes the primary winding 1250 and the secondary winding 1252 is the same as the transformer that includes the primary winding 250 and the secondary winding 252. As an example, the diode 1260 is the same as the diode 260. For example, the input capacitor 1270 is the same as the input capacitor 270. As an example, the output capacitor 1272 is the same as the output capacitor 272. For example, the supply capacitor 1274 is the same as the supply capacitor 274. As an example, the current sensing resistor 1280 is the same as the current sensing resistor 280. For example, the terminal 1202 (e.g., SW) is the same as the terminal 202 (e.g., SW). As an example, the terminal 1208 (e.g., VDD) is the same as the terminal 208 (e.g., VDD). For example, the pulse-width-modulation (PWM) control module 1222 is the same as the pulse-width-modulation (PWM) control module 222. As an example, the gate driver 1224 is the same as the gate driver 224. For example, the switch 1226 (e.g., a power switch) is the same as the switch 226 (e.g., a power switch). As an example, the transistor 1230 is the same as the transistor 230. For example, the diode 1232 is the same as the diode 232. As an example, the driver control module 1234 is the same as the driver control module 234. For example, the load 1292 is the same as the load 292.

As shown in FIG. 12, a terminal 1282 of the current sensing resistor 1280 is connected to the terminal 1206 (e.g., GND) of the control chip 1220, and a terminal 1284 of the current sensing resistor 1280 is biased to a system ground of the power supply system 1200 according to certain embodiments. For example, a terminal 1275 of the supply capacitor 1274 is connected to the terminal 1208 (e.g., VDD) of the control chip 1220, and a terminal 1277 of the supply capacitor 1274 is connected to the terminal 1282 of the current sensing resistor 1280 and the terminal 1206 (e.g., GND) of the control chip 1220. As an example, the terminal 1204 (e.g., CS) of the control chip 1220 is biased to the system ground.

In some embodiments, the control chip 1220 is similar to the control chip 220 as shown in FIG. 3 and/or FIG. 4 with certain modifications. For example, the PWM control module 1222 is connected to the terminal 1204 (e.g., CS) that is biased to the system ground. As an example, the switch 1226 (e.g., a power switch) is connected to the terminal 1206 (e.g., GND) that is connected to the terminal 1282 of the current sensing resistor 1280.

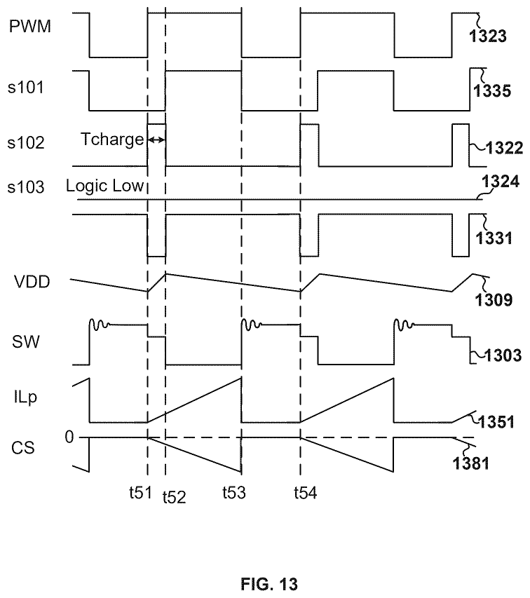

FIG. 13 shows simplified timing diagrams for the power supply system 1200 if the load 1292 is a non-light load as shown in FIG. 12 according to some embodiments of the present disclosure. These diagrams are merely examples, which should not unduly limit the scope of the claims. One of ordinary skill in the art would recognize many variations, alternatives, and modifications.

For example, the waveform 1323 represents, as a function of time, a pulse-width-modulation (PWM) signal generated by the PWM control module 1222. As an example, the waveform 1309 represents, as a function of time, a voltage at the terminal 1208 (e.g., VDD) of the control chip 1220. For example, the waveform 1335 represents, as a function of time, a control signal that is generated by the driver control module 1234 and received by the gate driver 1224. As an example, the waveform 1322 represents, as a function of time, a control signal that is generated by a signal control module of the driver control module 1234 and received by a state control module of the driver control module 1234. For example, the waveform 1324 represents, as a function of time, another control signal that is generated by the signal control module of the driver control module 1234 and received by the state control module of the driver control module 1234. As an example, the waveform 1331 represents, as a function of time, a control signal that is generated by the driver control module 1234 and received by the transistor 1230. For example, the waveform 1303 represents, as a function of time, a voltage at the terminal 1202 (e.g., SW) of the control chip 1220. As an example, the waveform 1351 represents, as a function of time, a primary current that flows through the primary winding 1250. For example, the waveform 1381 represents, as a function of time, a sensing voltage at the terminal 1204 (e.g., CS) of the control chip 1220.

According to certain embodiments, the transistor 1230 is a PMOS transistor. In some examples, at a rising edge of the PWM signal generated by the PWM control module 1222, the PMOS transistor 1230 becomes turned on to operate in the linear region and then remains in the linear region for a charging duration, wherein the length of the charging duration depends at least in part on the voltage of the terminal 1208 (e.g., VDD) at a rising edge of the PWM signal. For example, the length of the charging duration increases if the voltage of the terminal 1208 (e.g., VDD) at a rising edge of the PWM signal decreases. As an example, the length of the charging duration decreases if the voltage of the terminal 1208 (e.g., VDD) at a rising edge of the PWM signal increases. In certain examples, the waveform 1381 represents, as a function of time, the sensing voltage at the terminal 1204 (e.g., CS) with respect to a chip ground at the terminal 1206 (e.g., GND) of the control chip 1220. For example, when the primary current increases as shown by the waveform 1351, the sensing voltage decreases as shown by the waveform 1381. As an example, when the primary current decreases as shown by the waveform 1351, the sensing voltage increases as shown by the waveform 1381. According to some embodiments, in comparison with FIG. 5, time t₅₁ corresponds to time t₁, time t₅₂ corresponds to time t₂, time t₅₃ corresponds to time t₃, and time t₅₄ corresponds to time t₄.

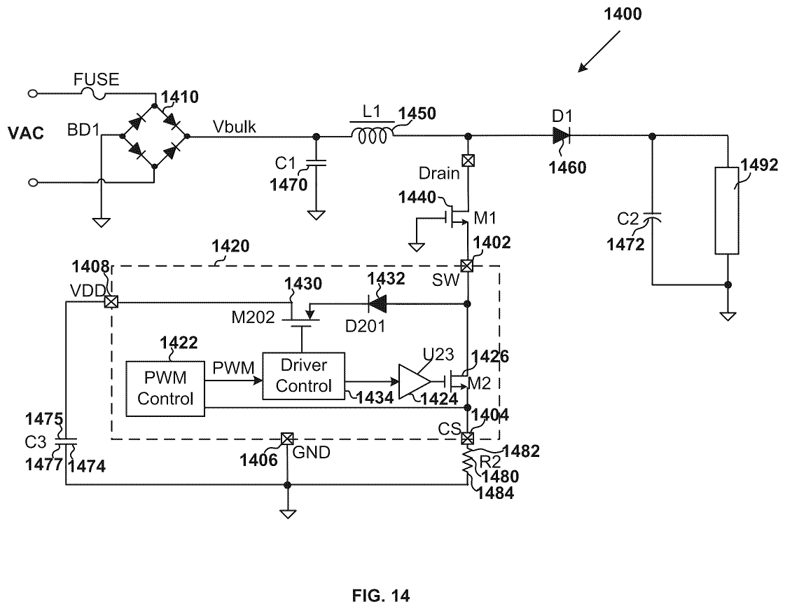

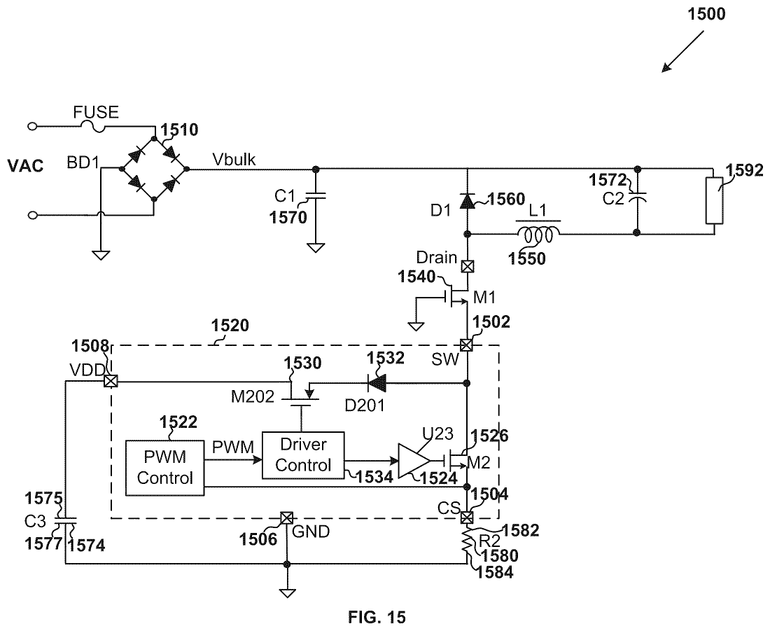

As shown in FIG. 2, the power supply system 200 (e.g., a switching power supply system) implements a flyback architecture. As mentioned above and further emphasized here, FIG. 2 is merely an example, which should not unduly limit the scope of the claims. One of ordinary skill in the art would recognize many variations, alternatives, and modifications. For example, the power supply system (e.g., a switching power supply system) implements a boost architecture (e.g., as shown by FIG. 14). As an example, the power supply system (e.g., a switching power supply system) implements a buck architecture (e.g., as shown in FIG. 15). For example, the power supply system (e.g., a switching power supply system) implements a buck-boost architecture.

FIG. 14 is a simplified diagram showing a power supply system with a GaN switch according to some embodiments of the present disclosure. This diagram is merely an example, which should not unduly limit the scope of the claims. One of ordinary skill in the art would recognize many variations, alternatives, and modifications. The power supply system 1400 (e.g., a switching power supply system) includes a full-wave rectifier 1410, a control chip 1420, a GaN switch 1440 (e.g., a GaN power switch), an inductive winding 1450, a diode 1460, an input capacitor 1470, an output capacitor 1472, a supply capacitor 1474, and a current sensing resistor 1480. The control chip 1420 includes a terminal 1402 (e.g., SW), a terminal 1404 (e.g., CS), a terminal 1406 (e.g., GND), and a terminal 1408 (e.g., VDD). Additionally, the control chip 1420 includes a pulse-width-modulation (PWM) control module 1422, a gate driver 1424, a switch 1426 (e.g., a power switch), a transistor 1430 (e.g., a supply transistor), a diode 1432, and a driver control module 1434. As an example, the power supply system 1400 (e.g., a switching power supply system) is used to provide power to a load 1492, wherein the load 1492 is configured to receive the power from the power supply system 1400 (e.g., a switching power supply system). For example, the power supply system 1400 (e.g., a switching power supply system) implements a boost architecture. As an example, the GaN switch 1440 (e.g., a GaN power switch) is a GaN transistor. For example, the power switch 1426 (e.g., a transistor) is an NMOS transistor. Although the above has been shown using a selected group of components for the power supply system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As an example, the full-wave rectifier 1410 is the same as the full-wave rectifier 210. For example, the GaN switch 1440 (e.g., a GaN power switch) is the same as the GaN switch 240 (e.g., a GaN power switch). As an example, the diode 1460 is the same as the diode 260. For example, the input capacitor 1470 is the same as the input capacitor 270. As an example, the output capacitor 1472 is the same as the output capacitor 272. For example, the supply capacitor 1474 is the same as the supply capacitor 274. As an example, the current sensing resistor 1480 is the same as the current sensing resistor 280. For example, the terminal 1402 (e.g., SW) is the same as the terminal 202 (e.g., SW). As an example, the terminal 1404 (e.g., CS) is the same as the terminal 204 (e.g., CS). For example, the terminal 1406 (e.g., GND) is the same as the terminal 206 (e.g., GND). As an example, the terminal 1408 (e.g., VDD) is the same as the terminal 208 (e.g., VDD). For example, the pulse-width-modulation (PWM) control module 1422 is the same as the pulse-width-modulation (PWM) control module 222. As an example, the gate driver 1424 is the same as the gate driver 224. For example, the switch 1426 (e.g., a power switch) is the same as the switch 226 (e.g., a power switch). As an example, the transistor 1430 is the same as the transistor 230. For example, the diode 1432 is the same as the diode 232. As an example, the driver control module 1434 is the same as the driver control module 234. For example, the load 1492 is the same as the load 292.

As shown in FIG. 14, a terminal 1482 of the current sensing resistor 1480 is connected to the terminal 1404 (e.g., CS) of the control chip 1420, and a terminal 1484 of the current sensing resistor 1480 is biased to a system ground of the power supply system 1400 according to certain embodiments. For example, a terminal 1475 of the supply capacitor 1474 is connected to the terminal 1408 (e.g., VDD) of the control chip 1420, and a terminal 1477 of the supply capacitor 1474 is biased to the system ground. As an example, the terminal 1406 (e.g., GND) of the control chip 1420 is biased to the system ground.

In some embodiments, the control chip 1420 is similar to the control chip 220 as shown in FIG. 3 and/or FIG. 4 with certain modifications. For example, the control chip 1420 supports the power supply system 1400 (e.g., a switching power supply system) that implements a boost architecture. As an example, the control chip 220 supports the power supply system 200 (e.g., a switching power supply system) that implements a flyback architecture. In some examples, a current that flows through the inductive winding 1450 of the power supply system 1400 corresponds to the primary current 251 that flows through the primary winding 250 of the power supply system 200.

FIG. 15 is a simplified diagram showing a power supply system with a GaN switch according to some embodiments of the present disclosure. This diagram is merely an example, which should not unduly limit the scope of the claims. One of ordinary skill in the art would recognize many variations, alternatives, and modifications. The power supply system 1500 (e.g., a switching power supply system) includes a full-wave rectifier 1510, a control chip 1520, a GaN switch 1540 (e.g., a GaN power switch), an inductive winding 1550, a diode 1560, an input capacitor 1570, an output capacitor 1572, a supply capacitor 1574, and a current sensing resistor 1580. The control chip 1520 includes a terminal 1502 (e.g., SW), a terminal 1504 (e.g., CS), a terminal 1506 (e.g., GND), and a terminal 1508 (e.g., VDD). Additionally, the control chip 1520 includes a pulse-width-modulation (PWM) control module 1522, a gate driver 1524, a switch 1526 (e.g., a power switch), a transistor 1530 (e.g., a supply transistor), a diode 1532, and a driver control module 1534. As an example, the power supply system 1500 (e.g., a switching power supply system) is used to provide power to a load 1592, wherein the load 1592 is configured to receive the power from the power supply system 1500 (e.g., a switching power supply system). For example, the power supply system 1500 (e.g., a switching power supply system) implements a buck architecture. As an example, the GaN switch 1540 (e.g., a GaN power switch) is a GaN transistor. For example, the power switch 1526 (e.g., a transistor) is an NMOS transistor. Although the above has been shown using a selected group of components for the power supply system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As an example, the full-wave rectifier 1510 is the same as the full-wave rectifier 210. For example, the GaN switch 1540 (e.g., a GaN power switch) is the same as the GaN switch 240 (e.g., a GaN power switch). As an example, the diode 1560 is the same as the diode 260. For example, the input capacitor 1570 is the same as the input capacitor 270. As an example, the output capacitor 1572 is the same as the output capacitor 272. For example, the supply capacitor 1574 is the same as the supply capacitor 274. As an example, the current sensing resistor 1580 is the same as the current sensing resistor 280. For example, the terminal 1502 (e.g., SW) is the same as the terminal 202 (e.g., SW). As an example, the terminal 1504 (e.g., CS) is the same as the terminal 204 (e.g., CS). For example, the terminal 1506 (e.g., GND) is the same as the terminal 206 (e.g., GND). As an example, the terminal 1508 (e.g., VDD) is the same as the terminal 208 (e.g., VDD). For example, the pulse-width-modulation (PWM) control module 1522 is the same as the pulse-width-modulation (PWM) control module 222. As an example, the gate driver 1524 is the same as the gate driver 224. For example, the switch 1526 (e.g., a power switch) is the same as the switch 226 (e.g., a power switch). As an example, the transistor 1530 is the same as the transistor 230. For example, the diode 1532 is the same as the diode 232. As an example, the driver control module 1534 is the same as the driver control module 234. For example, the load 1592 is the same as the load 292.

As shown in FIG. 15, a terminal 1582 of the current sensing resistor 1580 is connected to the terminal 1504 (e.g., CS) of the control chip 1520, and a terminal 1584 of the current sensing resistor 1580 is biased to a system ground of the power supply system 1500 according to certain embodiments. For example, a terminal 1575 of the supply capacitor 1574 is connected to the terminal 1508 (e.g., VDD) of the control chip 1520, and a terminal 1577 of the supply capacitor 1574 is biased to the system ground. As an example, the terminal 1506 (e.g., GND) of the control chip 1520 is biased to the system ground.

In some embodiments, the control chip 1520 is similar to the control chip 220 as shown in FIG. 3 and/or FIG. 4 with certain modifications. For example, the control chip 1520 supports the power supply system 1500 (e.g., a switching power supply system) that implements a buck architecture. As an example, the control chip 220 supports the power supply system 200 (e.g., a switching power supply system) that implements a flyback architecture. In some examples, a current that flows through the inductive winding 1550 of the power supply system 1500 corresponds to the primary current 251 that flows through the primary winding 250 of the power supply system 200.

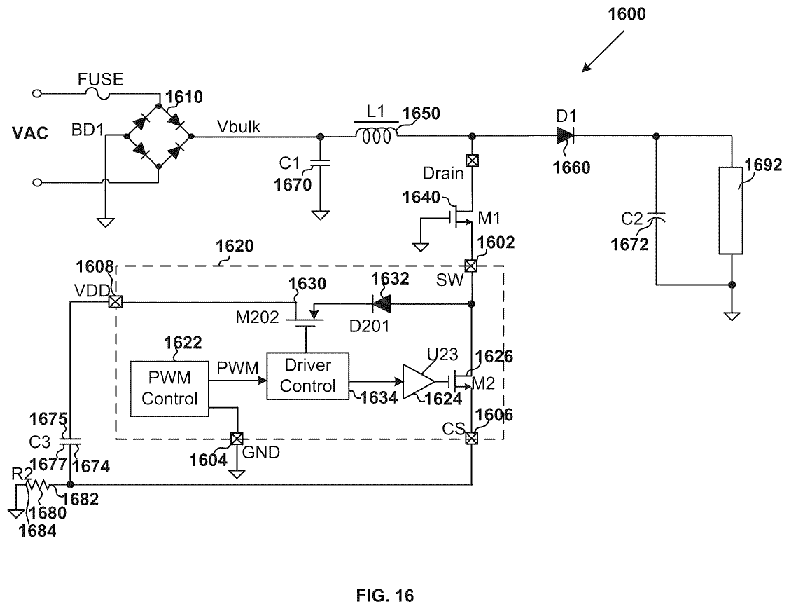

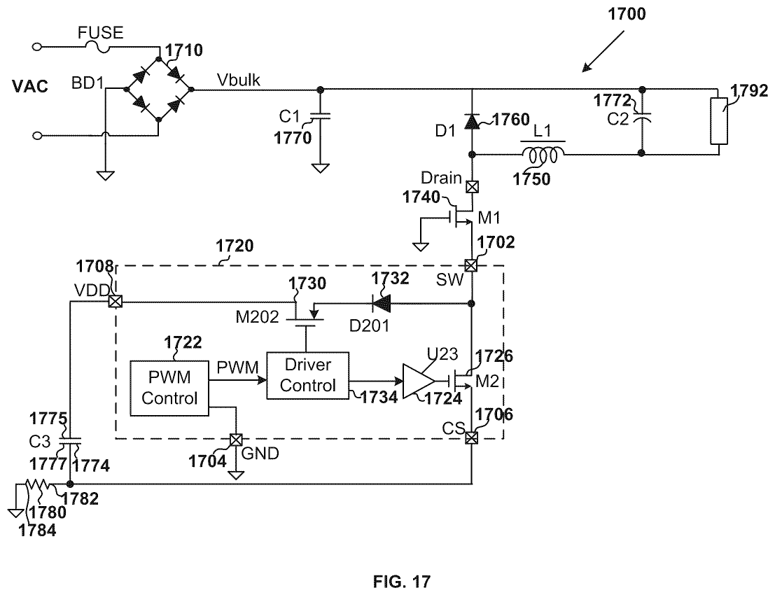

As shown in FIG. 12, the power supply system 1200 (e.g., a switching power supply system) implements a flyback architecture. As mentioned above and further emphasized here, FIG. 12 is merely an example, which should not unduly limit the scope of the claims. One of ordinary skill in the art would recognize many variations, alternatives, and modifications. For example, the power supply system (e.g., a switching power supply system) implements a boost architecture (e.g., as shown by FIG. 16). As an example, the power supply system (e.g., a switching power supply system) implements a buck architecture (e.g., as shown in FIG. 17). For example, the power supply system (e.g., a switching power supply system) implements a buck-boost architecture.

FIG. 16 is a simplified diagram showing a power supply system with a GaN switch according to some embodiments of the present disclosure. This diagram is merely an example, which should not unduly limit the scope of the claims. One of ordinary skill in the art would recognize many variations, alternatives, and modifications. The power supply system 1600 (e.g., a switching power supply system) includes a full-wave rectifier 1610, a control chip 1620, a GaN switch 1640 (e.g., a GaN power switch), an inductive winding 1650, a diode 1660, an input capacitor 1670, an output capacitor 1672, a supply capacitor 1674, and a current sensing resistor 1680. The control chip 1620 includes a terminal 1602 (e.g., SW), a terminal 1604 (e.g., CS), a terminal 1606 (e.g., GND), and a terminal 1608 (e.g., VDD). Additionally, the control chip 1620 includes a pulse-width-modulation (PWM) control module 1622, a gate driver 1624, a switch 1626 (e.g., a power switch), a transistor 1630 (e.g., a supply transistor), a diode 1632, and a driver control module 1634. As an example, the power supply system 1600 (e.g., a switching power supply system) is used to provide power to a load 1692, wherein the load 1692 is configured to receive the power from the power supply system 1600 (e.g., a switching power supply system). For example, the power supply system 1600 (e.g., a switching power supply system) implements a boost architecture. As an example, the GaN switch 1640 (e.g., a GaN power switch) is a GaN transistor. For example, the power switch 1626 (e.g., a transistor) is an NMOS transistor. Although the above has been shown using a selected group of components for the power supply system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As an example, the full-wave rectifier 1610 is the same as the full-wave rectifier 1210. For example, the GaN switch 1640 (e.g., a GaN power switch) is the same as the GaN switch 1240 (e.g., a GaN power switch). As an example, the diode 1660 is the same as the diode 1260. For example, the input capacitor 1670 is the same as the input capacitor 1270. As an example, the output capacitor 1672 is the same as the output capacitor 1272. For example, the supply capacitor 1674 is the same as the supply capacitor 1274. As an example, the current sensing resistor 1680 is the same as the current sensing resistor 1280. For example, the terminal 1602 (e.g., SW) is the same as the terminal 1202 (e.g., SW). As an example, the terminal 1604 (e.g., CS) is the same as the terminal 1204 (e.g., CS). For example, the terminal 1606 (e.g., GND) is the same as the terminal 1206 (e.g., GND). As an example, the terminal 1608 (e.g., VDD) is the same as the terminal 1208 (e.g., VDD). For example, the pulse-width-modulation (PWM) control module 1622 is the same as the pulse-width-modulation (PWM) control module 1222. As an example, the gate driver 1624 is the same as the gate driver 1224. For example, the switch 1626 (e.g., a power switch) is the same as the switch 1226 (e.g., a power switch). As an example, the transistor 1630 is the same as the transistor 1230. For example, the diode 1632 is the same as the diode 1232. As an example, the driver control module 1634 is the same as the driver control module 1234. For example, the load 1692 is the same as the load 1292.

As shown in FIG. 16, a terminal 1682 of the current sensing resistor 1680 is connected to the terminal 1606 (e.g., GND) of the control chip 1620, and a terminal 1684 of the current sensing resistor 1680 is biased to a system ground of the power supply system 1600 according to certain embodiments. For example, a terminal 1675 of the supply capacitor 1674 is connected to the terminal 1608 (e.g., VDD) of the control chip 1620, and a terminal 1677 of the supply capacitor 1674 is connected to the terminal 1682 of the current sensing resistor 1680 and the terminal 1606 (e.g., GND) of the control chip 1620. As an example, the terminal 1604 (e.g., CS) of the control chip 1620 is biased to the system ground.

In some embodiments, the control chip 1620 is similar to the control chip 1220 as shown in FIG. 3 and/or FIG. 4 with certain modifications. For example, the control chip 1620 supports the power supply system 1600 (e.g., a switching power supply system) that implements a boost architecture. As an example, the control chip 1220 supports the power supply system 1200 (e.g., a switching power supply system) that implements a flyback architecture. In some examples, a current that flows through the inductive winding 1650 of the power supply system 1600 corresponds to the primary current that flows through the primary winding 1250 of the power supply system 1200.

FIG. 17 is a simplified diagram showing a power supply system with a GaN switch according to some embodiments of the present disclosure. This diagram is merely an example, which should not unduly limit the scope of the claims. One of ordinary skill in the art would recognize many variations, alternatives, and modifications. The power supply system 1700 (e.g., a switching power supply system) includes a full-wave rectifier 1710, a control chip 1720, a GaN switch 1740 (e.g., a GaN power switch), an inductive winding 1750, a diode 1760, an input capacitor 1770, an output capacitor 1772, a supply capacitor 1774, and a current sensing resistor 1780. The control chip 1720 includes a terminal 1702 (e.g., SW), a terminal 1704 (e.g., CS), a terminal 1706 (e.g., GND), and a terminal 1708 (e.g., VDD). Additionally, the control chip 1720 includes a pulse-width-modulation (PWM) control module 1722, a gate driver 1724, a switch 1726 (e.g., a power switch), a transistor 1730 (e.g., a supply transistor), a diode 1732, and a driver control module 1734. As an example, the power supply system 1700 (e.g., a switching power supply system) is used to provide power to a load 1792, wherein the load 1792 is configured to receive the power from the power supply system 1700 (e.g., a switching power supply system). For example, the power supply system 1700 (e.g., a switching power supply system) implements a buck architecture. As an example, the GaN switch 1740 (e.g., a GaN power switch) is a GaN transistor. For example, the power switch 1726 (e.g., a transistor) is an NMOS transistor. Although the above has been shown using a selected group of components for the power supply system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

As an example, the full-wave rectifier 1710 is the same as the full-wave rectifier 1210. For example, the GaN switch 1740 (e.g., a GaN power switch) is the same as the GaN switch 1240 (e.g., a GaN power switch). As an example, the diode 1760 is the same as the diode 1260. For example, the input capacitor 1770 is the same as the input capacitor 1270. As an example, the output capacitor 1772 is the same as the output capacitor 1272. For example, the supply capacitor 1774 is the same as the supply capacitor 1274. As an example, the current sensing resistor 1780 is the same as the current sensing resistor 1280. For example, the terminal 1702 (e.g., SW) is the same as the terminal 1202 (e.g., SW). As an example, the terminal 1704 (e.g., CS) is the same as the terminal 1204 (e.g., CS). For example, the terminal 1706 (e.g., GND) is the same as the terminal 1206 (e.g., GND). As an example, the terminal 1708 (e.g., VDD) is the same as the terminal 1208 (e.g., VDD). For example, the pulse-width-modulation (PWM) control module 1722 is the same as the pulse-width-modulation (PWM) control module 1222. As an example, the gate driver 1724 is the same as the gate driver 1224. For example, the switch 1726 (e.g., a power switch) is the same as the switch 1226 (e.g., a power switch). As an example, the transistor 1730 is the same as the transistor 1230. For example, the diode 1732 is the same as the diode 1232. As an example, the driver control module 1734 is the same as the driver control module 1234. For example, the load 1792 is the same as the load 1292.

As shown in FIG. 17, a terminal 1782 of the current sensing resistor 1780 is connected to the terminal 1706 (e.g., GND) of the control chip 1720, and a terminal 1784 of the current sensing resistor 1780 is biased to a system ground of the power supply system 1700 according to certain embodiments. For example, a terminal 1775 of the supply capacitor 1774 is connected to the terminal 1708 (e.g., VDD) of the control chip 1720, and a terminal 1777 of the supply capacitor 1774 is connected to the terminal 1782 of the current sensing resistor 1780 and the terminal 1706 (e.g., GND) of the control chip 1720. As an example, the terminal 1704 (e.g., CS) of the control chip 1720 is biased to the system ground.

In some embodiments, the control chip 1720 is similar to the control chip 1220 as shown in FIG. 3 and/or FIG. 4 with certain modifications. For example, the control chip 1720 supports the power supply system 1700 (e.g., a switching power supply system) that implements a buck architecture. As an example, the control chip 1220 supports the power supply system 1200 (e.g., a switching power supply system) that implements a flyback architecture. In some examples, a current that flows through the inductive winding 1750 of the power supply system 1700 corresponds to the primary current that flows through the primary winding 1250 of the power supply system 1200.

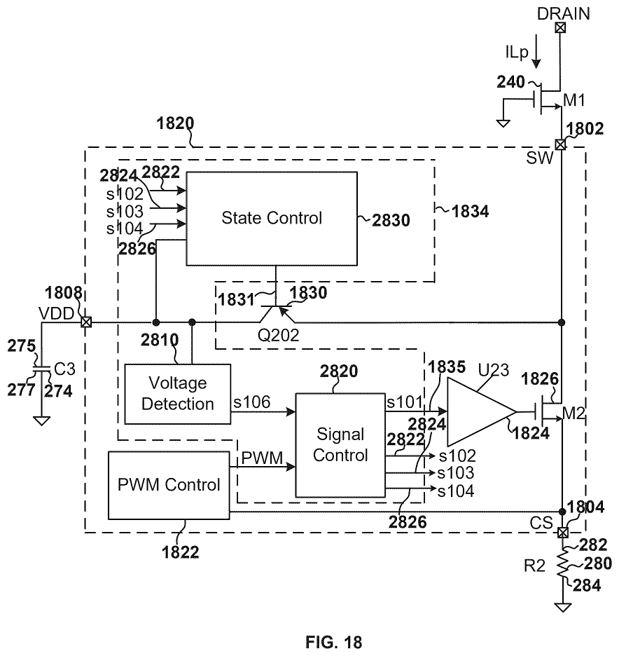

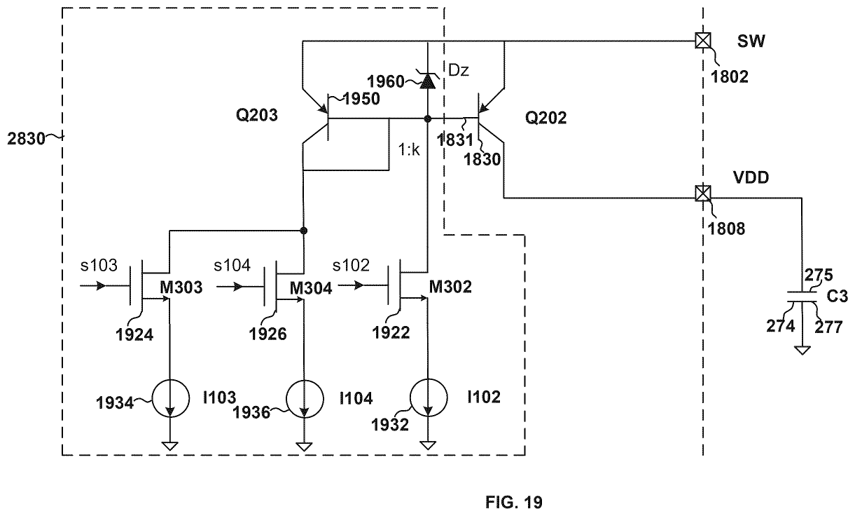

As mentioned above and further emphasized here, FIG. 2 is merely an example, which should not unduly limit the scope of the claims. One of ordinary skill in the art would recognize many variations, alternatives, and modifications. For example, the PMOS transistor 230 is replaced by a PNP bipolar transistor by modifying the control chip 220 into a different control chip (e.g., a control chip 1820 as shown by FIG. 18 and/or FIG. 19).

FIG. 18 is a simplified diagram showing the control chip that includes a bipolar transistor as part of a power supply system according to certain embodiments of the present disclosure. This diagram is merely an example, which should not unduly limit the scope of the claims. One of ordinary skill in the art would recognize many variations, alternatives, and modifications. For example, the control chip 1820 includes a terminal 1802 (e.g., SW), a terminal 1804 (e.g., CS), and a terminal 1808 (e.g., VDD). As an example, the control chip 1820 also includes another terminal (e.g., GND). The control chip 1820 includes a PWM control module 1822, a gate driver 1824, a switch 1826 (e.g., a power switch), a bipolar transistor 1830 (e.g., a supply transistor), and a driver control module 1834, and the driver control module 1834 includes a voltage detection module 2810, a signal control module 2820, and a state control module 2830. For example, the bipolar transistor 1830 (e.g., a supply transistor) is a PNP bipolar transistor. As an example, the power switch 1826 (e.g., a transistor) is an NMOS transistor. Although the above has been shown using a selected group of components for the control chip 1820, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to some embodiments, a comparison between the control chip 220 as shown in FIG. 3 and the control chip 1820 as shown in FIG. 18 shows that the control chip 220 is modified to become the control chip 1820. For example, the PMOS transistor 230 is replaced by the PNP bipolar transistor 1830. As an example, the diode 232 is removed. In certain examples, comparing the operation of the control chip 220 and the operation of the control chip 1820, the saturation region for the operation of the PMOS transistor 230 corresponds to the active region for the operation of the PNP bipolar transistor 1830, and the linear region for the operation of the PMOS transistor 230 corresponds to the saturation region for the operation of the PNP bipolar transistor 1830.

For example, the terminal 1802 (e.g., SW) is the same as the terminal 202 (e.g., SW). As an example, the terminal 1804 (e.g., CS) is the same as the terminal 204 (e.g., CS). For example, the terminal 1808 (e.g., VDD) is the same as the terminal 208 (e.g., VDD). As an example, the PWM control module 1822 is the same as the PWM control module 222. For example, the gate driver 1824 is the same as the gate driver 224. As an example, the switch 1826 (e.g., a power switch) is the same as the switch 226 (e.g., a power switch). For example, the voltage detection module 2810 is the same as the voltage detection module 310. As an example, the signal control module 2820 is the same as the signal control module 320.

As shown in FIG. 18, the signal control module 2820 generates control signals 1835, 2822, 2824 and 2826 according to certain embodiments. For example, the state control module 2830, based at least in part on control signals 2822, 2824 and 2826, generates a base current 1831 of the PNP bipolar transistor 1830 according to certain embodiments. As an example, the state control module 2830 uses the base current 1831 to control the operation of the PNP bipolar transistor 1830. In some examples, if the control signal 1835 is at a logic high level, the switch 1826 (e.g., a transistor) is closed (e.g., turned on). In certain examples, if the control signal 1835 is at a logic low level, the switch 1826 (e.g., a transistor) is open (e.g., turned off).

FIG. 19 is a simplified diagram showing the state control module 2830 as part of the control chip 1820 of the power supply system as shown in FIG. 18 according to some embodiments of the present disclosure. This diagram is merely an example, which should not unduly limit the scope of the claims. One of ordinary skill in the art would recognize many variations, alternatives, and modifications. The state control module 2830 includes control switches 1922, 1924 and 1926, bias current sources 1932, 1934 and 1936, a bipolar transistor 1950 (e.g., a PNP bipolar transistor), and a Zener diode 1960. Although the above has been shown using a selected group of components for the state control module, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

According to some embodiments, a comparison between the state control module 330 as shown in FIG. 4 and the state control module 2830 as shown in FIG. 19 shows that the state control module 330 is modified to become the state control module 2830. For example, the PMOS transistor 450 is replaced by the PNP bipolar transistor 1950. In certain examples, comparing the operation of the state control module 330 and the operation of the state control module 2830, the gate voltage 231 for the PMOS transistor 230 corresponds to the base current 1831 for the PNP bipolar transistor 1830.

For example, the control switch 1922 is the same as the control switch 422. As an example, the control switch 1924 is the same as the control switch 424. For example, the control switch 1926 is the same as the control switch 426. As an example, the bias current source 1932 is the same as the bias current source 432. For example, the bias current source 1934 is the same as the bias current source 434. As an example, the bias current source 1936 is the same as the bias current source 436. For example, the Zener diode 1960 is the same as the Zener diode 460.

In certain embodiments, the bipolar transistor 1950 (e.g., a PNP bipolar transistor) is connected to the bipolar transistor 1830 (e.g., a PNP bipolar transistor) to form a current mirror. In some examples, a collector current of the bipolar transistor 1830 (e.g., a PNP bipolar transistor) is equal to a collector current of the bipolar transistor 1950 (e.g., a PNP bipolar transistor) multiplied by a mirror ratio (e.g., k). In certain examples, the Zener diode 1960 provides base-emitter voltage clamp protection for the bipolar transistor 1950 (e.g., a PNP bipolar transistor), and the Zener diode 1960 provides base-emitter voltage clamp protection for the bipolar transistor 1830 (e.g., a PNP bipolar transistor), wherein the Zener diode 1960 has a breakdown voltage (e.g., V₀). For example, if a base voltage at the base of the bipolar transistor 1830 (e.g., a PNP bipolar transistor) is equal to a voltage of the terminal 1802 (e.g., SW), the bipolar transistor 1830 (e.g., a PNP bipolar transistor) is turned off. As an example, if the base voltage at the base of the bipolar transistor 1830 (e.g., a PNP bipolar transistor) is equal to the voltage of the terminal 1802 (e.g., SW) minus the breakdown voltage (e.g., V₀) of the Zener diode 1960, the bipolar transistor 1830 (e.g., a PNP bipolar transistor) is turned on (e.g., operating in a saturation region and/or operating in an active region).

In some embodiments, if the control switch 1922 (e.g., a transistor) is open (e.g., turned off), the control switch 1924 (e.g., a transistor) is open (e.g., turned off), and the control switch 1926 (e.g., a transistor) is open (e.g., turned off), the PNP bipolar transistor 1830 is turned off. In certain embodiments, if the control switch 1922 (e.g., a transistor) is closed (e.g., turned on), the control switch 1924 (e.g., a transistor) is open (e.g., turned off), and the control switch 1926 (e.g., a transistor) is open (e.g., turned off), the PNP bipolar transistor 1830 is turned on, operating in the saturation region. For example, the collector current of the bipolar transistor 1830 (e.g., a PNP bipolar transistor) has a significant magnitude.

According to some embodiments, if the control switch 1922 (e.g., a transistor) is open (e.g., turned off), the control switch 1924 (e.g., a transistor) is closed (e.g., turned on), and the control switch 1926 (e.g., a transistor) is open (e.g., turned off), the PNP bipolar transistor 1830 is turned on, operating in the active region. For example, the collector current of the bipolar transistor 1830 (e.g., a PNP bipolar transistor) is equal to a current that is generated by the bias current source 1934 multiplied by a mirror ratio (e.g., k). According to certain embodiments, if the control switch 1922 (e.g., a transistor) is open (e.g., turned off), the control switch 1924 (e.g., a transistor) is open (e.g., turned off), and the control switch 1926 (e.g., a transistor) is closed (e.g., turned on), the PNP bipolar transistor 1830 is turned on, operating in the active region. For example, the collector current of the bipolar transistor 1830 (e.g., a PNP bipolar transistor) is equal to a current that is generated by the bias current source 1936 multiplied by a mirror ratio (e.g., k).

The present disclosure provides a power supply system with a GaN switch, wherein the power supply system includes a transformer that includes a primary winding and a secondary winding but not any auxiliary winding, and the power supply system also does not use any high-voltage startup unit, therefore reducing system cost according to some embodiments. For example, the power supply system includes a driver control module that provides optimized control to minimize power supply loss and/or achieve highly efficient power supply control.

According to certain embodiments of the present disclosure, a control chip (e.g., a control circuit) of a power supply system with a GaN switch employs a single supply transistor to form a sole power supply path between the GaN switch and a supply capacitor. For example, by controlling the state of the supply transistor, the magnitude of a charging current that flows through the supply path including the supply transistor is managed. As an example, the charging current charges the supply capacitor so that the supply capacitor provides a supply voltage to the control chip (e.g., a control circuit) of the power supply system with the GaN switch, thus eliminating any need for a high-voltage startup unit and/or an auxiliary winding of a transformer and also reducing system cost. For example, the control chip (e.g., a control circuit) of the power supply system includes a driver control module that provides optimized control to minimize power supply loss and/or achieve highly efficient power supply control.

According to some embodiments of the present disclosure, a power supply system includes a GaN switch, a control chip (e.g., a control circuit), and a supply capacitor for providing a supply voltage to the control chip (e.g., a control circuit), and the control chip (e.g., a control circuit) includes a pulse-width-modulation (PWM) control module, a driver control module, a power switch, and a supply transistor, wherein the power switch is connected between the GaN switch and a system ground of the power supply system directly or through a current sensing resistor, and the supply transistor is connected between the supply capacitor and the GaN switch directly or through a diode. For example, the driver control module of the control chip (e.g., a control circuit) is configured to, based at least in part on the supply voltage, a load state of the power supply system, and/or a pulse-width-modulation (PWM) signal generated by the PWM control module, generate a control signal to close and/or open the power switch of the control chip and also generate another control signal to control a state of the supply transistor of the control chip. As an example, the driver control module of the control chip (e.g., a control circuit) is configured to control the charging of the supply capacitor through at least the supply transistor. For example, the load state of the power supply system is a load of the power supply system being a light load and/or the load of the power supply system being a non-light load. In certain examples, the supply transistor is a PMOS transistor or a PNP bipolar transistor. For example, the supply transistor is the PMOS transistor, the state of the supply transistor is being turned off, being turned on in the saturation region, or being turned on in the linear region. As an example, the supply transistor is the NPN bipolar transistor, the state of the supply transistor is being turned off, being turned on in the active region, or being turned on in the saturation region.

According to certain embodiments, a control chip for a power supply system with a GaN switch includes: a first terminal connected to the GaN switch; a second terminal connected to a supply capacitor, the supply capacitor being configured to provide a supply voltage to the second terminal; a supply transistor connected between the second terminal and the first terminal; and a driver control module configured to generate a supply control signal to turn on the supply transistor and further configured to generate the supply control signal to turn off the supply transistor; wherein the control chip is configured to: in response to the supply transistor being turned on, allow a charging current to flow from the first terminal through the second terminal to charge the supply capacitor; and in response to the supply transistor being turned off, not allow any charging current to flow from the first terminal through the second terminal. For example, the control chip is implemented according to at least FIG. 2.

As an example, the supply transistor is a MOS transistor. For example, the driver control module is configured to generate the supply control signal to turn on the supply transistor to operate in a saturation region. As an example, the driver control module is configured to generate the supply control signal to turn on the supply transistor to operate in a linear region. For example, the MOS transistor is a PMOS transistor.

For example, the supply transistor is a bipolar transistor. As an example, the driver control module is configured to generate the supply control signal to turn on the supply transistor to operate in an active region. For example, the driver control module is configured to generate the supply control signal to turn on the supply transistor to operate in a saturation region. As an example, the bipolar transistor is a PNP bipolar transistor. For example, the control chip further includes: a diode connected between the supply transistor and the first terminal; wherein the supply transistor is connected between the second terminal and the first terminal through the diode.

As an example, the control chip further includes: a first switch connected between the first terminal and a third terminal; and the third terminal connected to a current sensing resistor. For example, the driver control module is further configured to generate a first control signal to close the first switch and further configured to generate the first control signal to open the first switch; wherein the control chip is further configured to: in response to the first switch being closed, allow a sensing current to flow from the first terminal through the third terminal to the current sensing resistor to generate a sensing voltage; and in response to the first switch being open, not allow any sensing current to flow from the first terminal through the third terminal to the current sensing resistor. As an example, the driver control module is further configured to generate the supply control signal to turn on the supply transistor and the first control signal to open the first switch, allowing the charging current to flow from the first terminal through the second terminal but not allowing any sensing current to flow from the first terminal through the third terminal to the current sensing resistor. For example, the driver control module is further configured to generate the supply control signal to turn off the supply transistor and the first control signal to close the first switch, allowing the sensing current to flow from the first terminal through the third terminal to the current sensing resistor but not allowing any charging current to flow from the first terminal through the second terminal. As an example, the driver control module is further configured to generate the supply control signal to turn off the supply transistor and the first control signal to open the first switch, not allowing any charging current to flow from the first terminal through the second terminal and not allowing any sensing current to flow from the first terminal through the third terminal.

For example, the control chip further includes: a PWM control module configured to receive the sensing voltage and generate a PWM signal based at least in part on the sensing voltage; wherein the driver control module is configured to receive the PWM signal. As an example, the driver control module is further configured to generate the supply control signal and the first control signal based at least in part on the PWM signal, the supply voltage, and a load state of a load, the load being configured to receive power from the power supply system. For example, the driver control module is further configured to generate the supply control signal in response to at least a rising edge of the PWM signal. As an example, the driver control module is further configured to generate the supply control signal in response to at least a falling edge of the PWM signal. For example, the load state of the load is the load being a light load. As an example, the load state of the load is the load being a non-light load.

According to some embodiments, a control chip for a power supply system with a GaN switch includes: a first terminal connected to the GaN switch; a second terminal connected to a supply capacitor, the supply capacitor being configured to provide a supply voltage to the second terminal; a third terminal connected to a current sensing resistor; a supply transistor connected between the second terminal and the first terminal through a diode; a first switch connected between the first terminal and the third terminal; and a driver control module configured to: generate a supply control signal to turn on the supply transistor and turn off the supply transistor; and generate a first control signal to close and open the first switch; wherein the control chip is configured to: in response to the supply transistor being turned on, allow a charging current to flow from the first terminal through the second terminal to charge the supply capacitor; and in response to the supply transistor being turned off, not allow any charging current to flow from the first terminal through the second terminal; wherein the control chip is further configured to: in response to the first switch being closed, allow a sensing current to flow from the first terminal through the third terminal to the current sensing resistor to generate a sensing voltage; and in response to the first switch being open, not allow any sensing current to flow from the first terminal through the third terminal to the current sensing resistor. For example, the control chip is implemented according to at least FIG. 2.

According to certain embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to: in response to at least a rising edge of the PWM signal, change the supply control signal from the second voltage level to the first voltage level to start charging the supply capacitor. For example, the control chip is implemented according to at least FIG. 2 and FIG. 5.

As an example, the control chip further includes: a diode connected between the supply transistor and the first terminal; wherein the supply transistor is connected between the second terminal and the first terminal through the diode. For example, the driver control module is further configured to, after changing the supply control signal from the second voltage level to the first voltage level, keep the supply control signal at the first voltage level for a charging duration when the supply capacitor is being charged. As an example, the charging duration depends at least in part on the supply voltage at the rising edge of the PWM signal. For example, if the supply voltage at the rising edge of the PWM signal increases, the charging duration decreases; and if the supply voltage at the rising edge of the PWM signal decreases, the charging duration increases. As an example, the driver control module is further configured to, after the charging duration, change the supply control signal from the first voltage level to the second voltage level to stop charging the supply capacitor.

For example, the control chip further includes: a first switch connected between the first terminal and a third terminal; and the third terminal connected to a current sensing resistor; wherein the driver control module is further configured to generate a first control signal to close and open the first switch. As an example, the driver control module is further configured to, during the charging duration, keep the first control signal at a first logic level to open the first switch. For example, the driver control module is further configured to, after the charging duration, change the first control signal from the first logic level to a second logic level to close the first switch. As an example, the driver control module is further configured to, in response to at least a falling edge of the PWM signal, change the first control signal from the second logic level to the first logic level to open the first switch.

For example, the control chip further includes: a gate driver configured to receive the first control signal and generate a drive signal based at least in part on the first control signal; wherein the gate driver is further configured to output the drive signal to the first switch. As an example, the driver control module includes: a voltage detection module configured to receive the supply voltage and generate a detection signal based at least in part on the supply voltage; a signal control module configured to receive the detection signal and the PWM signal and generate the first control signal and one or more second control signals based at least in part on the detection signal and the PWM signal; and a state control module configured to receive the one or more second control signals and generate the supply control signal based at least in part on the one or more second control signals. For example, the driver control module is further configured to generate the supply control signal at the first voltage level to turn on the supply transistor to operate in a liner region in response to a load that is configured to receive power from the power supply system being a non-light load; wherein the supply transistor is a MOS transistor.

According to some embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to, at a rising edge of the PWM signal: compare the supply voltage with a predetermined charging threshold; and if the supply voltage is smaller than the predetermined charging threshold, change the supply control signal from the second voltage level to the first voltage level to start charging the supply capacitor. For example, the control chip is implemented according to at least FIG. 2 and FIG. 7.

As an example, the control chip further includes: a diode connected between the supply transistor and the first terminal; wherein the supply transistor is connected between the second terminal and the first terminal through the diode. For example, the driver control module is further configured to, after changing the supply control signal from the second voltage level to the first voltage level, keep the supply control signal at the first voltage level for a charging duration when the supply capacitor is being charged. As an example, the charging duration is constant in length. For example, the driver control module is further configured to, after the charging duration, change the supply control signal from the first voltage level to the second voltage level to stop charging the supply capacitor.

As an example, the control chip further includes: a first switch connected between the first terminal and a third terminal; and the third terminal connected to a current sensing resistor; wherein the driver control module is further configured to generate a first control signal to close and open the first switch. For example, the driver control module is further configured to, during the charging duration, keep the first control signal at a first logic level to open the first switch. As an example, the driver control module is further configured to, after the charging duration, change the first control signal from the first logic level to a second logic level to close the first switch. For example, the driver control module is further configured to, in response to at least a falling edge of the PWM signal, change the first control signal from the second logic level to the first logic level to open the first switch.

According to certain embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to: in response to at least a falling edge of the PWM signal, change the supply control signal from the second voltage level to the first voltage level to start charging the supply capacitor. For example, the control chip is implemented according to at least FIG. 2 and FIG. 8.

As an example, the control chip and further includes: a diode connected between the supply transistor and the first terminal; wherein the supply transistor is connected between the second terminal and the first terminal through the diode. For example, the driver control module is further configured to, after changing the supply control signal from the second voltage level to the first voltage level, keep the supply control signal at the first voltage level for a charging duration when the supply capacitor is being charged. As an example, the charging duration depends at least in part on the supply voltage at the falling edge of the PWM signal. For example, if the supply voltage at the falling edge of the PWM signal increases, the charging duration decreases; and if the supply voltage at the falling edge of the PWM signal decreases, the charging duration increases. As an example, the driver control module is further configured to, after the charging duration, change the supply control signal from the first voltage level to the second voltage level to stop charging the supply capacitor.

For example, the control chip further includes: a first switch connected between the first terminal and a third terminal; and the third terminal connected to a current sensing resistor; wherein the driver control module is further configured to generate a first control signal to close and open the first switch. As an example, the driver control module is further configured to, in response to at least the falling edge of the PWM signal, change the first control signal from a first logic level to a second logic level to open the first switch. For example, the driver control module is further configured to, during the charging duration, keep the first control signal at the second logic level to open the first switch. As an example, the driver control module is further configured to, in response to at least a rising edge of the PWM signal, change the first control signal from the second logic level to the first logic level to close the first switch.

For example, the control chip further includes: a gate driver configured to receive the first control signal and generate a drive signal based at least in part on the first control signal; wherein the gate driver is further configured to output the drive signal to the first switch. As an example, the driver control module includes: a voltage detection module configured to receive the supply voltage and generate a detection signal based at least in part on the supply voltage; a signal control module configured to receive the detection signal and the PWM signal and generate the first control signal and one or more second control signals based at least in part on the detection signal and the PWM signal; and a state control module configured to receive the one or more second control signals and generate the supply control signal based at least in part on the one or more second control signals. For example, the driver control module is further configured to generate the supply control signal at the first voltage level to turn on the supply transistor to operate in a liner region in response to a load that is configured to receive power from the power supply system being a non-light load; wherein the supply transistor is a MOS transistor.

According to some embodiments, a control chip for a power supply system with a GaN switch includes: a first terminal connected to the GaN switch; a second terminal connected to a supply capacitor configured to provide a supply voltage to the second terminal; a supply transistor connected between the second terminal and the first terminal; a PWM control module configured to generate a PWM signal; and a driver control module configured to receive the PWM signal and generate a supply control signal based at least in part on the PWM signal and the supply voltage; wherein the driver control module is further configured to: generate the supply control signal at a first voltage level to turn on the supply transistor to charge the supply capacitor; and generate the supply control signal at a second voltage level to turn off the supply transistor; wherein the driver control module is further configured to, at a falling edge of the PWM signal: compare the supply voltage with a predetermined charging threshold; and if the supply voltage is smaller than the predetermined charging threshold, change the supply control signal from the second voltage level to the first voltage level to start charging the supply capacitor. For example, the control chip is implemented according to at least FIG. 2 and FIG. 10.

As an example, the control chip further includes: a diode connected between the supply transistor and the first terminal; wherein the supply transistor is connected between the second terminal and the first terminal through the diode. For example, the driver control module is further configured to, after changing the supply control signal from the second voltage level to the first voltage level, keep the supply control signal at the first voltage level for a charging duration when the supply capacitor is being charged. As an example, the charging duration is constant in length. For example, the driver control module is further configured to, after the charging duration, change the supply control signal from the first voltage level to the second voltage level to stop charging the supply capacitor.

As an example, the control chip further includes: a first switch connected between the first terminal and a third terminal; and the third terminal connected to a current sensing resistor; wherein the driver control module is further configured to generate a first control signal to close and open the first switch. For example, the driver control module is further configured to, in response to at least the falling edge of the PWM signal, change the first control signal from a first logic level to a second logic level to open the first switch. As an example, the driver control module is further configured to, during the charging duration, keep the first control signal at the second logic level to open the first switch. For example, the driver control module is further configured to, in response to at least a rising edge of the PWM signal, change the first control signal from the second logic level to the first logic level to close the first switch.

For example, some or all components of various embodiments of the present disclosure each are, individually and/or in combination with at least another component, implemented using one or more software components, one or more hardware components, and/or one or more combinations of software and hardware components. As an example, some or all components of various embodiments of the present disclosure each are, individually and/or in combination with at least another component, implemented in one or more circuits, such as one or more analog circuits and/or one or more digital circuits. For example, various embodiments and/or examples of the present disclosure can be combined.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

1. A control chip for a power supply system with a GaN switch, the control chip comprising:
a first terminal connected to the GaN switch;
a second terminal connected to a supply capacitor, the supply capacitor being configured to provide a supply voltage to the second terminal;
a supply transistor connected between the second terminal and the first terminal; and
a driver control module configured to generate a supply control signal to turn on the supply transistor and further configured to generate the supply control signal to turn off the supply transistor;
wherein the control chip is configured to:
in response to the supply transistor being turned on, allow a charging current to flow from the first terminal through the second terminal to charge the supply capacitor; and
in response to the supply transistor being turned off, not allow any charging current to flow from the first terminal through the second terminal.

2. The control chip of claim 1 wherein the supply transistor is a MOS transistor.

3. The control chip of claim 2 wherein the driver control module is configured to generate the supply control signal to turn on the supply transistor to operate in a saturation region.

4. The control chip of claim 2 wherein the driver control module is configured to generate the supply control signal to turn on the supply transistor to operate in a linear region.

5. The control chip of claim 2 wherein the MOS transistor is a PMOS transistor.

6. The control chip of claim 1 wherein the supply transistor is a bipolar transistor.

7. The control chip of claim 6 wherein the driver control module is configured to generate the supply control signal to turn on the supply transistor to operate in an active region.

8. The control chip of claim 6 wherein the driver control module is configured to generate the supply control signal to turn on the supply transistor to operate in a saturation region.

9. The control chip of claim 6 wherein the bipolar transistor is a PNP bipolar transistor.

10. The control chip of claim 1, and further comprising:
a diode connected between the supply transistor and the first terminal;
wherein the supply transistor is connected between the second terminal and the first terminal through the diode.

11. The control chip of claim 1, and further comprising:
a first switch connected between the first terminal and a third terminal; and
the third terminal connected to a current sensing resistor.

12. The control chip of claim 11 wherein:
the driver control module is further configured to generate a first control signal to close the first switch and further configured to generate the first control signal to open the first switch;
wherein the control chip is further configured to:
in response to the first switch being closed, allow a sensing current to flow from the first terminal through the third terminal to the current sensing resistor to generate a sensing voltage; and
in response to the first switch being open, not allow any sensing current to flow from the first terminal through the third terminal to the current sensing resistor.

13. The control chip of claim 12 wherein the driver control module is further configured to generate the supply control signal to turn on the supply transistor and the first control signal to open the first switch, allowing the charging current to flow from the first terminal through the second terminal but not allowing any sensing current to flow from the first terminal through the third terminal to the current sensing resistor.

14. The control chip of claim 13 wherein the driver control module is further configured to generate the supply control signal to turn off the supply transistor and the first control signal to close the first switch, allowing the sensing current to flow from the first terminal through the third terminal to the current sensing resistor but not allowing any charging current to flow from the first terminal through the second terminal.

15. The control chip of claim 14 wherein the driver control module is further configured to generate the supply control signal to turn off the supply transistor and the first control signal to open the first switch, not allowing any charging current to flow from the first terminal through the second terminal and not allowing any sensing current to flow from the first terminal through the third terminal.

16. The control chip of claim 12, and further comprising:
a PWM control module configured to receive the sensing voltage and generate a PWM signal based at least in part on the sensing voltage;
wherein the driver control module is configured to receive the PWM signal.

17. The control chip of claim 16 wherein the driver control module is further configured to generate the supply control signal and the first control signal based at least in part on the PWM signal, the supply voltage, and a load state of a load, the load being configured to receive power from the power supply system.

18. The control chip of claim 17 wherein the driver control module is further configured to generate the supply control signal in response to at least a rising edge of the PWM signal.

19. The control chip of claim 17 wherein the driver control module is further configured to generate the supply control signal in response to at least a falling edge of the PWM signal.

20. The control chip of claim 17 wherein the load state of the load is the load being a light load.

21. The control chip of claim 17 wherein the load state of the load is the load being a non-light load.

22. A control chip for a power supply system with a GaN switch, the control chip comprising:
a first terminal connected to the GaN switch;
a second terminal connected to a supply capacitor, the supply capacitor being configured to provide a supply voltage to the second terminal;
a third terminal connected to a current sensing resistor;
a supply transistor connected between the second terminal and the first terminal through a diode;
a first switch connected between the first terminal and the third terminal; and
a driver control module configured to:
generate a supply control signal to turn on the supply transistor and turn off the supply transistor; and
generate a first control signal to close and open the first switch;
wherein the control chip is configured to:
in response to the supply transistor being turned on, allow a charging current to flow from the first terminal through the second terminal to charge the supply capacitor; and
in response to the supply transistor being turned off, not allow any charging current to flow from the first terminal through the second terminal;
wherein the control chip is further configured to:
in response to the first switch being closed, allow a sensing current to flow from the first terminal through the third terminal to the current sensing resistor to generate a sensing voltage; and
in response to the first switch being open, not allow any sensing current to flow from the first terminal through the third terminal to the current sensing resistor.

23.-66. (canceled)
